(19) United States
(12) Patent Application Publication
(10) Pub. No.: US 2024/0414611 A1
(43) Pub. Date: Dec. 12, 2024

(54) METHOD OF ACCESS AND MOBILITY MANAGEMENT FUNCTION (AMF), METHOD OF NEXT GENERATION-RADIO ACCESS NETWORK (NG-RAN) NODE, METHOD OF USER EQUIPMENT (UE), AMF NG-RAN NODE AND UE

(71) Applicant: NEC Corporation, Minato-ku, Tokyo (JP)

(72) Inventors: Kundan Tiwari, Tokyo (JP); Toshiyuki Tamura, Tokyo (JP); Iskren Ianev, Tokyo (JP)

(73) Assignee: NEC Corporation, Minato-ku, Tokyo (JP)

(21) Appl. No.: 18/700,826

(22) PCT Filed: Oct. 27, 2022
(86) PCT No.: PCT/JP2022/040217

§ 371 Date: Apr. 12, 2024

(30) Foreign Application Priority Data
Nov. 5, 2021 (IN) 202111050760

(51) Int. Cl. H04W 36/08; H04W 36/00; H04W 84/04

(52) U.S. Cl. CPC H04W 36/08; H04W 36/0061; H04W 84/042

(57) ABSTRACT

The system design disclosed by R2-2108928 works with the basic 5GS network structure. On the other hand, there are many variants of 5GS available according to 3GPP specifications. As the system design disclosed by R2-2108928 does not consider the variants of 5GS available according to 3GPP specifications, there is a case where the system design disclosed by R2-2108928 does not work in the variants. A method of an Access and Mobility Management Function (AMF) apparatus includes sending a first message including a Public Land Mobile Network Identifier (PLMN ID) and Single Network Slice Selection Assistance Information (S-NSSAI), receiving a second message including the PLMN ID and the S-NSSAI associated with an identifier, and sending the S-NSSAI associated with the identifier.

### TECHNICAL FIELD

This present disclosure relates to a method of an Access and Mobility Management Function (AMF) apparatus, a method of a Next Generation-Radio Access Network (NG-RAN) node, a method of a User Equipment (UE), a method of a Master Node (MN), an AMF apparatus, an NG-RAN node, a UE, and a MN.

### BACKGROUND ART

In the 3GPP RAN WG2 #115-e meeting, R2-2108928, LS on Slice list and priority information for cell reselection, (NPL 2) was agreed. This document discloses the following technical aspects.

The following information will be used in UE AS for cell reselection evaluation:
Slice specific absolute priority of each of the frequency supporting a slice (“Slice Info”)
The UE receives slice info using RRC signaling (System Information and/or dedicated RRC signaling)
List of Slices with Slice Priority for cell reselection.

For the List of Slices with Slice Priority, UE Access Stratum (AS) expects to receive a list from NAS containing a slice priority for each of the slices contained in the list when/before it moves to RRC_IDLE/RRC_INACTIVE and when the list and/or priorities changes while the UE is in RRC_IDLE/RRC_INACTIVE.

This cell reselection evaluation is designed based on the following designed principle.
Frequency priority mapping for each slice (slice->frequency (ies)->absolute priority of each of the frequency) is provided to a UE.
Frequency priority mapping for each of the slice (slice->frequency (ies)->absolute priority of each of the frequency) is part of the “slice info” agreed to be provided to the UE using both broadcast and dedicated signaling.

In addition, the Slice Group concept was also disclosed, where a slice group consists of one or multiple slices, one slice belongs to one and only one slice group and each slice group is uniquely identified by a slice group identifier.

### CITATION LIST

### Non Patent Literature

[NPL 1] 3GPP TR 21.905: “Vocabulary for 3GPP Specifications”. V17.0.0 (2020-07)
[NPL 2] 3GPP RAN WG2 #115-e meeting R2-2108928: “LS on Slice list and priority information for cell reselection”. (2021-08)
[NPL 3] 3GPP TS 38.413: “NG-RAN; NG Application Protocol (NGAP)”. V16.7.0 (2021-10)
[NPL 4] 3GPP TS 23.251: “Network sharing; Architecture and functional description”. V16.0.0 (2020-07)
[NPL 5] 3GPP TS 36.300: “Evolved Universal Terrestrial Radio Access (E-UTRA) and Evolved Universal Terrestrial Radio Access Network (E-UTRAN); Overall description; Stage 2”. V16.6.0 (2021-06)
[NPL 6] 3GPP TS 37.340: “NR; Multi-connectivity; Overall description; Stage-2”. V16.7.0 (2021-09)

### SUMMARY OF INVENTION

### Technical Problem

The system design disclosed by NPL 2 works with the basic 5GS network structure. On the other hand, there are many variants of 5GS available according to 3GPP specifications.

As the system design disclosed by NPL 2 does not consider the variants of 5GS available according to 3GPP specifications, there is a case where the system design disclosed by NPL 2 does not work in the variants.

For example, NPL 4 discloses the RAN sharing by multiple PLMN operators, and there is a case where the system design disclosed by NPL 2 does not properly work in the shared RAN.

For example, NPL 6 discloses the Multi-Radio Dual Connectivity, and there is a case where the system design disclosed by NPL 2 does not properly work in the Multi-Radio Dual Connectivity environment.

### Solution to Problem

In an aspect of the present disclosure, a method of an Access and Mobility Management Function (AMF) apparatus includes sending a first message including a Public Land Mobile Network Identifier (PLMN ID) and Single Network Slice Selection Assistance Information (S-NSSAI), receiving a second message including the PLMN ID and the S-NSSAI associated with an identifier, and sending the S-NSSAI associated with the identifier.

In an aspect of the present disclosure, a method of a Next Generation-Radio Access Network (NG-RAN) node includes receiving a first message including a Public Land Mobile Network Identifier (PLMN ID) and Single Network Slice Selection Assistance Information (S-NSSAI), sending a second message including the PLMN ID and the S-NSSAI associated with an identifier, and sending a third message including the identifier associated with the PLMN ID.

In an aspect of the present disclosure, a method of a User Equipment (UE) includes receiving a first message including a Public Land Mobile Network Identifier (PLMN ID) and Single Network Slice Selection Assistance Information (S-NSSAI) associated with an identifier, receiving a second message including the identifier associated with the PLMN ID, and performing a cell selection or a cell reselection after receiving the first message and the second message.

In an aspect of the present disclosure, a method of an Access and Mobility Management Function (AMF) apparatus includes receiving a first message including information indicating range of an identifier, sending a Public Land Mobile Network Identifier (PLMN ID) and Single Network Slice Selection Assistance Information (S-NSSAI) associated with the identifier, and sending the S-NSSAI associated with the identifier.

In an aspect of the present disclosure, a method of a Next Generation-Radio Access Network (NG-RAN) node includes sending a first message including information indicating range of an identifier, receiving a Public Land Mobile Network Identifier (PLMN ID) and Single Network Slice Selection Assistance Information (S-NSSAI) associated with the identifier, and sending a third message including the identifier associated with the PLMN ID.

In an aspect of the present disclosure, a method of a Master Node (MN) includes sending a Group Identifier (GP ID) identifying a group which includes Single Network Slice Selection Assistance Information (S-NSSAI), information indicating priority of a frequency band and information indicating a frequency band used by a Secondary Node (SN).

In an aspect of the present disclosure, a method of a Master Node (MN) includes sending Group Identifier (GP ID) identifying a group which includes Single Network Slice Selection Assistance Information (S-NSSAI), and information indicating priority of a frequency band. The information indicating priority of the frequency band includes priority of frequency band combination which includes a frequency band of the MN and a frequency band of a Secondary Node (SN).

In an aspect of the present disclosure, a method of a User Equipment (UE) includes receiving a Group Identifier (GP ID) identifying a group which includes Single Network Slice Selection Assistance Information (S-NSSAI), information indicating priority of a frequency band and information indicating a frequency band used by a Secondary Node (SN), and performing a cell selection or a cell reselection based on the GP ID, the information indicating priority of the frequency band and the information indicating a frequency band used by the SN.

In an aspect of the present disclosure, a method of a User Equipment (UE) includes receiving a first Group Identifier (GP ID) identifying a group which includes first Single Network Slice Selection Assistance Information (S-NSSAI), and information indicating priority of a frequency band, receiving a list of a Master Node (MN), and a second Group Identifier (GP ID) identifying a group which includes second S-NSSAI, and performing a cell selection or a cell reselection based on the first GP ID, the information indicating priority of the frequency band, the list and the second GP ID.

In an aspect of the present disclosure, an Access and Mobility Management Function (AMF) apparatus includes means for sending a first message including a Public Land Mobile Network Identifier (PLMN ID) and Single Network Slice Selection Assistance Information (S-NSSAI), means for receiving a second message including the PLMN ID and the S-NSSAI associated with an identifier, and means for sending the S-NSSAI associated with the identifier.

In an aspect of the present disclosure, a Next Generation-Radio Access Network (NG-RAN) node includes means for receiving a first message including a Public Land Mobile Network Identifier (PLMN ID) and Single Network Slice Selection Assistance Information (S-NSSAI), means for sending a second message including the PLMN ID and the S-NSSAI associated with an identifier, and means for sending a third message including the identifier associated with the PLMN ID.

In an aspect of the present disclosure, a User Equipment (UE) includes means for receiving a first message including a Public Land Mobile Network Identifier (PLMN ID) and Single Network Slice Selection Assistance Information (S-NSSAI) associated with an identifier, means for receiving a second message including the identifier associated with the PLMN ID, and means for performing a cell selection or a cell reselection after receiving the first message and the second message.

In an aspect of the present disclosure, an Access and Mobility Management Function (AMF) apparatus includes means for receiving a first message including information indicating range of an identifier, means for sending a Public Land Mobile Network Identifier (PLMN ID) and Single Network Slice Selection Assistance Information (S-NSSAI) associated with the identifier, and means for sending the S-NSSAI associated with the identifier.

In an aspect of the present disclosure, a Next Generation-Radio Access Network (NG-RAN) node includes means for sending a first message including information indicating range of an identifier, means for receiving a Public Land Mobile Network Identifier (PLMN ID) and Single Network Slice Selection Assistance Information (S-NSSAI) associated with the identifier, and means for sending a third message including the identifier associated with the PLMN ID.

In an aspect of the present disclosure, a Master Node (MN) includes means for sending a Group Identifier (GP ID) identifying a group which includes Single Network Slice Selection Assistance Information (S-NSSAI), information indicating priority of a frequency band and information indicating a frequency band used by a Secondary Node (SN).

In an aspect of the present disclosure, a Master Node (MN) includes means for sending Group Identifier (GP ID) identifying a group which includes Single Network Slice Selection Assistance Information (S-NSSAI), and information indicating priority of a frequency band. The information indicating priority of the frequency band includes priority of frequency band combination which includes a frequency band of the MN and a frequency band of a Secondary Node (SN).

In an aspect of the present disclosure, a User Equipment (UE) includes means for receiving a Group Identifier (GP ID) identifying a group which includes Single Network Slice Selection Assistance Information (S-NSSAI), information indicating priority of a frequency band and information indicating a frequency band used by a Secondary Node (SN), and means for performing a cell selection or a cell reselection based on the GP ID, the information indicating priority of the frequency band and the information indicating a frequency band used by the SN.

In an aspect of the present disclosure, a User Equipment (UE) includes means for receiving a first Group Identifier (GP ID) identifying a group which includes first Single Network Slice Selection Assistance Information (S-NSSAI), and information indicating priority of a frequency band, means for receiving a list of a Master Node (MN), and a second Group Identifier (GP ID) identifying a group which includes second S-NSSAI, and means for performing a cell selection or a cell reselection based on the first GP ID, the information indicating priority of the frequency band, the list and the second GP ID.

### BRIEF DESCRIPTION OF DRAWINGS

FIG. 1 illustrates new information in the UE for a cell selection and a cell reselection.

FIG. 2 illustrates slice information.

FIG. 3 is a signaling diagram of a first example of the first Aspect.

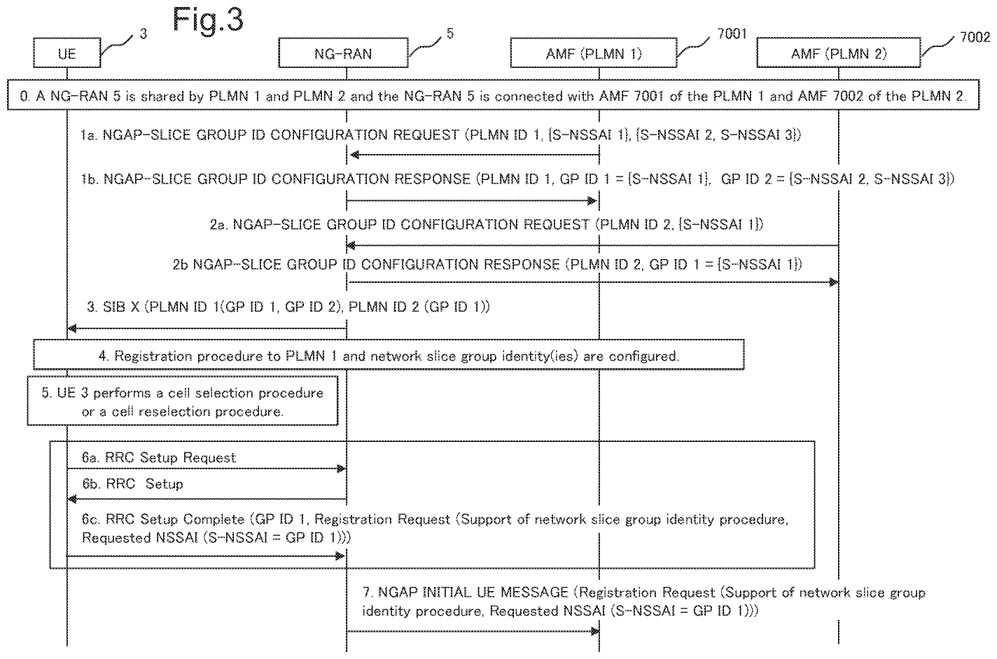

FIG. 4 is a signaling diagram of a second example of the first Aspect.

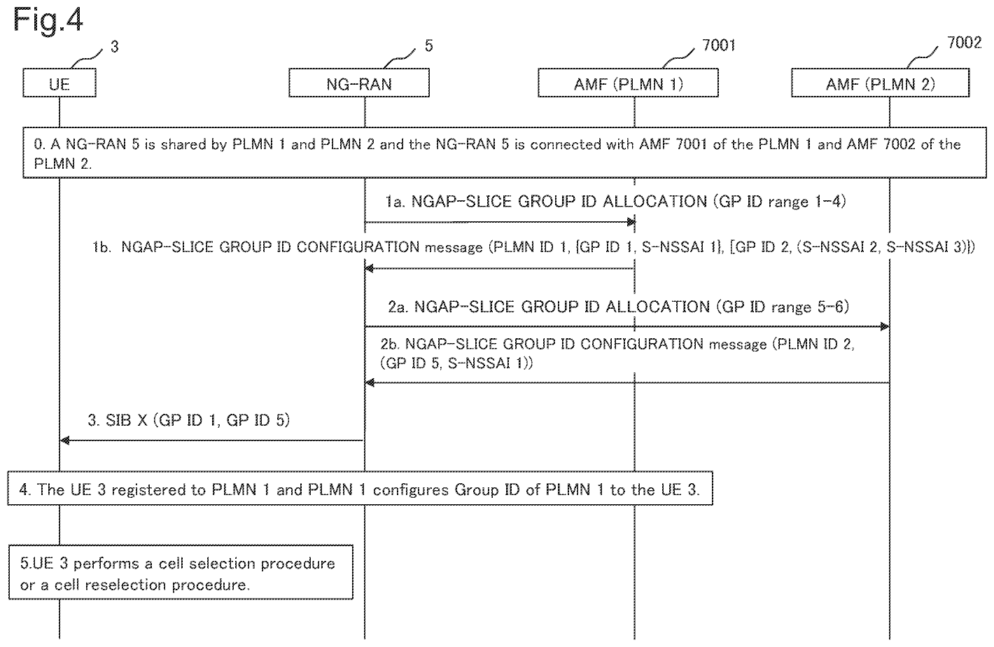

FIG. 5 is a signaling diagram of a first example of the second Aspect.

FIG. 6 is a signaling diagram of a second example of the second Aspect.

FIG. 7 is a flow chart of the second example of the second Aspect.

FIG. 8 is a signaling diagram of a first variant of a second example of the second Aspect.

FIG. 9 is a signaling diagram of a second variant of a second example of the second Aspect.

FIG. 10 is a diagram illustrating a system overview.

FIG. 11 is a block diagram illustrating a User equipment (UE).

FIG. 12 is a block diagram illustrating an (R) AN node.

FIG. 13 is a diagram illustrating System overview of (R) AN node based on O-RAN architecture.

FIG. 14 is a block diagram illustrating a Radio Unit (RU).

FIG. 15 is a block diagram illustrating a Distributed Unit (DU).

FIG. 16 is a block diagram illustrating a Centralized Unit (CU).

FIG. 17 is a block diagram illustrating an Access and Mobility Management Function (AMF).

FIG. 18 is a block diagram illustrating a Unified Data Management (UDM).

### DESCRIPTION OF EMBODIMENTS

### <Abbreviations>

For the purposes of the present document, the abbreviations given in NPL 1 and the following apply. An abbreviation defined in the present document takes precedence over the definition of the same abbreviation, if any, in NPL 1.

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QOS Identifier |
| AF | Application Function |
| AMF | Access and Mobility Management Function |
| AMF-G | Geographically selected Access and Mobility |
| | Management Function |
| AMF-NG | Non-Geographically selected Access and Mobility |
| | Management Function |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BCCH | Broadcast Control Channel |
| BMCA | Best Master Clock Algorithm |
| BSF | Binding Support Function |
| CAG | Closed Access Group |
| CAPIF | Common API Framework for 3GPP northbound APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| GPSI | Generic Public Subscription Identifier |
| GUAMI | Globally Unique AMF Identifier |
| GUTI | Globally Unique Temporary UE Identity |
| HR | Home Routed (roaming) |
| IAB | Integrated access and backhaul |
| IMEI/TAC | IMEI Type Allocation Code |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| MFBR | Maximum Flow Bit Rate |
| MICO | Mobile Initiated Connection Only |
| MITM | Man In the Middle |
| MNC | Mobile Network Code |
| MPS | Multimedia Priority Service |
| MPTCP | Multi-Path TCP Protocol |
| N3IWF | Non-3GPP InterWorking Function |
| N3GPP | Non-3GPP access |
| N5CW | Non-5G-Capable over WLAN |
| NAI | Network Access Identifier |
| NAS | Non-Access-Stratum |
| NEF | Network Exposure Function |
| NF | Network Function |
| NGAP | Next Generation Application Protocol |
| NID | Network identifier |
| NPN | Non-Public Network |
| NR | New Radio |
| NRF | Network Repository Function |
| NSI ID | Network Slice Instance Identifier |
| NSSAA | Network Slice-Specific Authentication and Authorization |
| NSSAAF | Network Slice-Specific Authentication and Authorization |
| | Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RAT | Radio Access Technology |
| RG | Residential Gateway |
| RIM | Remote Interference Management |
| RQA | Reflective QoS Attribute |
| RQI | Reflective QoS Indication |
| RSN | Redundancy Sequence Number |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SEPP | Security Edge Protection Proxy |
| SMF | Session Management Function |
| SMSF | Short Message Service Function |
| SN | Sequence Number |
| SN name | Serving Network Name. |
| SNPN | Stand-alone Non-Public Network |
| S-NSSAI | Single Network Slice Selection Assistance Information |
| SSC | Session and Service Continuity |
| SSCMSP | Session and Service Continuity Mode Selection Policy |
| SST | Slice/Service Type |
| SUCI | Subscription Concealed Identifier |
| SUPI | Subscription Permanent Identifier |
| SV | Software Version |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UPF | User Plane Function |
| URLLC | Ultra Reliable Low Latency Communication |
| URRP-AMF | UE Reachability Request Parameter for AMF |
| URSP | UE Route Selection Policy |
| VID | VLAN Identifier |
| VLAN | Virtual Local Area Network |
| VPLMN | Visited PLMN |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### <Definitions>

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

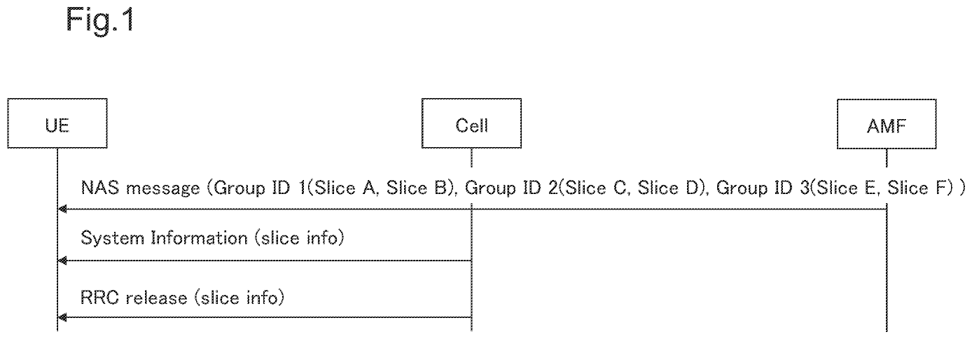

The FIG. 1 illustrates an example of new information available in the User Equipment (UE) for at least one of a cell selection and a cell reselection based on network slice priority.

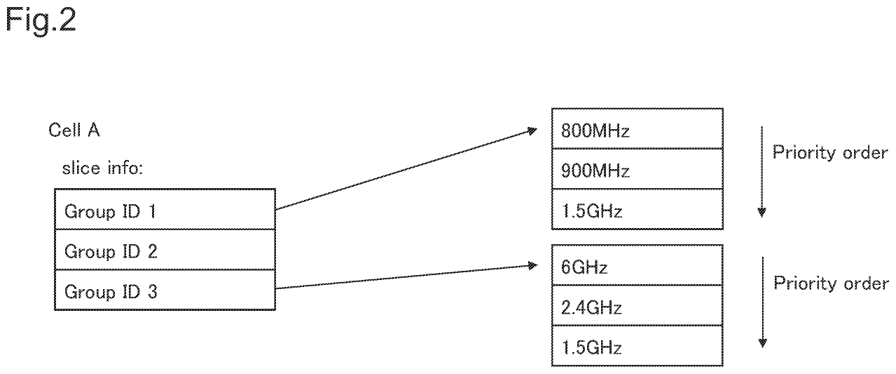

The FIG. 2 explains an example of new slice info that is provided to the UE. Note that this illustration does not show a structure of slice info. The slice info may be called as slice information in this disclosure.

This disclosure enables 5GS to perform the cell selection and cell reselection based on network slice priority per user (UE) based on broadcasting information applicable to various network configurations of the 5GS. For example, RAN is shared by multiple PLMN operators. Another example is that a RAN is structured with Multi-Radio Dual Connectivity.

### <First Aspect>

NPL 4 discloses the RAN sharing by multiple PLMN operators. In this case multiple 5GCs are connected to the RAN. This option in 5GS is called as a Multi-Operator Core Network (MOCN). If the MOCN is structured, the broadcast system information is broadcasted in each cell in shared radio access network and includes information concerning available core network operators in the shared network. The system information may be called as broadcast system information in this disclosure.

The broadcast system information includes a basic set of PLMN IDs and optionally one or more additional set of PLMN IDs. The available core network operators are the same for all cells of a Tracking Area in a shared RAN. The basic and the additional sets allow different PLMNs or sets of PLMNs to have different cell ID and TAC.

A supporting UE (e.g., the UE supporting the RAN sharing) decodes the broadcast system information and takes the information concerning available core network operators into account in a network selection, cell selection procedure(s) and cell reselection procedure(s).

It appears that the system design disclosed by NPL 2 does not properly work in the shared RAN. According to NPL 2, the group ID is provided by the core network over NAS layer and each group ID is associated to network slices. On the other hand, the supported group ID is provided by RAN over AS layer. As each group ID and associated network slices are different among connected operators, it needs a mechanism to coordinate group ID to be meaningful for all connected operators.

This disclosure discloses a mechanism that enables a cell selection and a cell reselection based on network slice priority in the 5GS where RAN is shared by multiple PLMN operators.

<First example of the First Aspects:>

This disclosure discloses a method to support broadcasting of a network slice group identity (or network slice group identities) in a cell shared by multiple PLMNs. The Next Generation-Radio Access Network (NG-RAN) is shared by multiple PLMNs. Each AMF of the PLMNs, connected to the same NG-RAN, sends an NGAP message to the NG-RAN. The NGAP message may be an existing NGAP message or a new NGAP message. The NGAP message includes a PLMN ID and a grouped network slice(s) that are supported by the AMF. The NG-RAN allocates a network slice group identity to each grouped network slice(s) and indicates the network slice group identity(ies) and associated network slice(s) to the AMF. The AMF stores the network slice(s) and associated network slice group identity(ies).

When a UE indicating a UE support of network slice group identity feature registers to the AMF of the PLMN by a registration procedure, the AMF sends the network slice(s) and the associated slice group identity(ies) to the UE by a registration accept message. When the UE receives the network slice(s) and the associated slice group identity(ies), the UE stores this information (e.g., the network slice and the associated slice group identity(ies)) and uses this stored information to determine whether a cell supports a particular network slice by checking if the network slice group identity associated with the particular network slice is broadcasted in a SIB or not. The SIB may be an existing SIB or a new SIB. The SIB may be System Information Block and may be called as a SIB message in this disclosure. If the network slice group identity that is associated to the particular network slice is broadcasted in the SIB, the UE determines that the cell supports the particular network slice and stays tuned to the cell. Tuning to the cell may be expressed as selecting or reselecting the cell.

The detailed processes of the first example of the first Aspect are as described below.

Step 0. An NG-RAN 5 is shared by PLMN 1 and PLMN 2, and the NG-RAN 5 is connected with AMF 7001 of the PLMN 1 and AMF 7002 of the PLMN 2. The AMF 7001 may be included in Core network (CN) 1. The AMF 7002 may be included in CN 2.

Step 1a. The AMF 7001 sends, to the NG-RAN 5, an existing NGAP message or a new NGAP message including that the PLMN ID 1 and list of grouped S-NSSAI(s) supported by the AMF 7001 requesting the NG-RAN 5 to assign or allocate a network slice group identity. The NGAP message may be expressed as a NGAP-SLICE GROUP ID CONFIGURATION REQUEST message. The NGAP-SLICE GROUP ID CONFIGURATION REQUEST message may include information elements: PLMN ID 1, {S-NSSAI 1} and {S-NSSAI 2, S-NSSAI 3}. For example, in a case where the AMF 7001 supports a network slice 1 indicated by S-NSSAI 1, a network slice 2 indicated by S-NSSAI 2 and a network slice 3 indicated by S-NSSAI 3, the AMF 7001 groups the network slices, e.g., a first network slice group including S-NSSAI 1 and a second network slice group including S-NSSAI 2 and S-NSSAI 3. The AMF 7001 may send, to the NG-RAN 5, the NGAP-SLICE GROUP ID CONFIGURATION REQUEST message including PLMN ID 1 and a list of the two network slice groups, {S-NSSAI1} and {S-NSSAI2, S-NSSAI 3}. The PLMN ID 1 may indicate PLMN ID of the AMF 7001. “{S-NSSAI1}” and “{S-NSSAI2, S-NSSAI 3}” may mean that S-NSSAIs 1, 2 and 3 are grouped to the first network slice group including S-NSSAI 1 and the second network slice group including S-NSSAIs 2 and 3. The AMF 7001 may send, to the NG-RAN 5, NGAP-SLICE GROUP ID CONFIGURATION REQUEST message including PLMN ID 1 and information which indicates the first network slice group including S-NSSAI 1 and the second network slice group including S-NSSAIs 2 and 3.

Step 1b. The NG-RAN 5 assigns or allocates a network slice group identity to each grouped S-NSSAI(s) received in the step 1a and sends an existing NGAP message or a new NGAP message to the AMF 7001. The NGAP message may be expressed as a NGAP-SLICE GROUP ID CONFIGURATION RESPONSE message. The NGAP-SLICE GROUP ID CONFIGURATION RESPONSE message may include information elements: PLMN ID 1, GP ID 1= {S-NSSAI1}, and GP ID 2= {S-NSSAI 2, S-NSSAI 3}. For example, in a case where the NG-RAN 5 receives the NGAP-SLICE GROUP ID CONFIGURATION REQUEST from the AMF 7001, the NG-RAN 5 may assign GP ID 1 (or a group ID 1) to the first network slice group including S-NSSAI 1 and assigns GP ID 2 (or a group ID 2) to the second network slice group including S-NSSAI 2 and S-NSSAI 3. The NG-RAN 5 may be expressed as a gNB, a base station, a (R) AN node, an NG-RAN node or any other. The NG-RAN 5 sends, to the AMF 7001, the NGAP-SLICE GROUP ID CONFIGURATION RESPONSE message including PLMN ID 1, the first network slice group to which GP ID 1 is assigned, and the second network slice group to which GP ID 2 is assigned. “GP ID 1= {S-NSSAI1}” and “GP ID 2= {S-NSSAI 2, S-NSSAI 3}” may mean that GP ID 1 is assigned to the first network slice group including S-NSSAI 1 and GP ID 2 is assigned to the second network slice group including S-NSSAIs 2 and 3. The NG-RAN 5 may send, to the AMF 7001, NGAP-SLICE GROUP ID CONFIGURATION RESPONSE message including PLMN ID 1 and information which indicates that GP ID 1 is assigned to the first network slice group including S-NSSAI 1 and GP ID 2 is assigned to the second network slice group including S-NSSAIs 2 and 3.

Instead of “GP ID 1= {S-NSSAI1}, GP ID 2= {S-NSSAI 2, S-NSSAI 3}” or in addition to “GP ID 1= {S-NSSAI1}, GP ID 2= {S-NSSAI 2, S-NSSAI 3}”, the NGAP-SLICE GROUP ID CONFIGURATION RESPONSE message may include a list of S-NSSAI(s) and an associated network slice group identity. For example, the NGAP-SLICE GROUP ID CONFIGURATION RESPONSE may include a first list which includes S-NSSAI 1 and is associated with GP ID 1 (or a network slice group identity 1). The NGAP-SLICE GROUP ID CONFIGURATION RESPONSE may further include a second list which includes S-NSSAIs 2 and 3 and is associated with GP ID 2 (or a network slice group identity 2).

Step 2a. Similarly, the AMF 7002 sends an existing NGAP message or a new NGAP message including that the PLMN ID 2 and list of grouped S-NSSAI(s) supported by the AMF 7002 requesting the NG-RAN 5 to assign or allocate a network slice group identity. The NGAP message may be expressed as a NGAP-SLICE GROUP ID CONFIGURATION REQUEST message. The NGAP-SLICE GROUP ID CONFIGURATION REQUEST message may include information elements: PLMN ID 2 and {S-NSSAI 1}. For example, in a case where the AMF 7002 supports a network slice 1 indicated by S-NSSAI 1, the AMF 7002 groups the network slice, e.g., a network slice group including S-NSSAI 1. The AMF 7002 may send, to the NG-RAN 5, the NGAP-SLICE GROUP ID CONFIGURATION REQUEST message including PLMN ID 2 and a list of the network slice group, {S-NSSAI 1}. The PLMN ID 2 may indicate PLMN ID of the AMF 7002. “{S-NSSAI 1}” may mean that S-NSSAI 1 is grouped to the network slice group. The AMF 7002 may send, to the NG-RAN 5, NGAP-SLICE GROUP ID CONFIGURATION REQUEST message including PLMN ID 2 and information which indicates the network slice group including S-NSSAI 1.

Step 2b. The NG-RAN 5 assigns or allocates a network slice group identity to each grouped S-NSSAI(s) received in the step 2a and sends an existing NGAP message or a new NGAP message to the AMF 7002. The NGAP message may be expressed as a NGAP-SLICE GROUP ID CONFIGURATION RESPONSE message. The NGAP-SLICE GROUP ID CONFIGURATION RESPONSE message may include information elements: PLMN ID 2 and GP ID 1= {S-NSSAI1}. For example, in a case where the NG-RAN 5 receives the NGAP-SLICE GROUP ID CONFIGURATION REQUEST message from the AMF 7002, the NG-RAN 5 may assign GP ID 1 (or a group ID 1) to the network slice group including S-NSSAI 1. The NG-RAN 5 may be expressed as a gNB, a base station, a (R) AN node, an NG-RAN node or any other. The NG-RAN 5 sends, to the AMF 7002, the NGAP-SLICE GROUP ID CONFIGURATION RESPONSE message including PLMN ID 2 and the network slice group which GP ID 1 is assigned to. “GP ID 1= {S-NSSAI1}” may mean that GP ID 1 is assigned to the network slice group including S-NSSAI 1. The NG-RAN 5 may send, to the AMF 7002, NGAP-SLICE GROUP ID CONFIGURATION RESPONSE message including PLMN ID 2 and information which indicates that GP ID 1 is assigned to the network slice group including S-NSSAI 1.

Instead of “GP ID 1= {S-NSSAI1}” or in addition to “GP ID 1= {S-NSSAI1}”, the NGAP-SLICE GROUP ID CONFIGURATION RESPONSE message may include a list of S-NSSAI(s) and an associated network slice group identity. For example, the NGAP-SLICE GROUP ID CONFIGURATION RESPONSE may include a list which includes S-NSSAI 1 and is associated with GP ID 1 (or a network slice group identity 1).

Step 3. A cell connected to the NG-RAN 5 broadcasts a list of network slice group identity(ies) supported by the cell for each PLMN in a new SIB or an existing SIB. The following format is an example of the SIB. I.e., the cell broadcasts a supported network slice group identity (or supported network slice group identities) per PLMN basis.

SIB X (PLMN ID 1 (GP ID 1, GP ID 2), PLMN ID 2 (GP ID 1))

For example, a gNB or a base station or a (R) AN node or an NG-RAN node may broadcast a SIB or a SIB message including the list of network slice group identity(ies) in the cell per PLMN basis. The list of network slice group identity(ies) may include GP ID 1 and GP ID 2 which are associated with PLMN ID 1, and GP ID 1 which is associated with PLMN ID 2. “SIB X (PLMN ID 1 (GP ID 1, GP ID 2), PLMN ID 2 (GP ID 1))” may mean that the SIB or SIB message includes GP ID 1 and GP ID 2 which are associated with PLMN ID 1, and GP ID 1 which is associated with PLMN ID 2.

Step 4. The UE 3 initiates a registration procedure to the AMF 7001 of the PLMN 1 by sending a registration request message including UE capability information which indicates whether the UE 3 supports a network slice group identity feature. The UE capability information may indicate a UE support of a network slice group identity feature in this disclosure. For example, in a case where the UE 3 is configured to recognize or understand the above SIB format or contents of the SIB or the SIB message, the UE 3 supports a network slice group identity feature. The SIB format may be SIB X (PLMN ID 1 (GP ID 1, GP ID 2), PLMN ID 2 (GP ID 1)). The contents of the SIB or the SIB message may include the list of network slice group identity(ies) in the cell per PLMN basis. In this case, the UE 3 sends a registration request message including the UE capability information which indicates that the UE 3 supports a network slice group identity feature. The network slice group identity feature may mean to recognize or understand the network slice group identity and to interact with associated node(s). The associated node(s) may be expressed as the AMF and/or the NG-RAN and/or any other core network nodes. The registration request message may include a Requested NSSAI.

During the registration procedure the AMF 7001 sends a list of the S-NSSAI(s) and associated network slice group identity(ies) to the UE 3 in an existing NAS message or in a new NAS message. The NAS message may be expressed as a registration accept message or a UE configuration update message. For example, in a case where the UE 3 indicates that the UE 3 supports the network slice group identity feature, the AMF 7001 sends the list of the S-NSSAI(s) and the associated network slice group identity(ies) to the UE 3.

For example, the list of the S-NSSAI(s) and the associated network slice group identity(ies) which the AMF 7001 sends may be the same to one received from the NG-RAN 5 in step 1b. For example, the list of the S-NSSAI(s) and the associated network slice group identity(ies) may indicate GP ID 1= {S-NSSAI 1} and GP ID 2= {S-NSSAI 2, S-NSSAI 3}. For example, the list of the S-NSSAI(s) and the associated network slice group identity(ies) may indicate a first list which includes S-NSSAI 1 and is associated with GP ID 1 (or the network slice group identity 1). The list of the S-NSSAI(s) and the associated network slice group identity(ies) may also indicate a second list which includes S-NSSAIs 2 and 3 and is associated with GP ID 2 (the network slice group identity 2).

The AMF 7001 may also send an Allowed NSSAI and a Configured NSSAI to the UE 3 in the NAS message during the registration procedure. The AMF 7001 may send a list of the S-NSSAI(s) and associated network slice group identity(ies) to the UE 3 for all S-NSSAIs in the Configured NSSAI.

Instead of the registration procedure to the AMF 7001, the UE 3 may perform a registration procedure to the AMF 7002 of PLMN 2. The registration procedure to the AMF 7002 of PLMN 2 may be performed similarly as described above. For example, the AMF 7001 may be altered to the AMF 7002, and the list of the S-NSSAI(s) and the associated network slice group identity(ies) which the AMF 7002 sends may be the same to one received from the NG-RAN 5 in step 2b. The UE 3 may perform both the registration procedure to the AMF 7001 of PLMN 1 and the registration procedure to the AMF 7002 of PLMN 2. For simplicity, the following steps and Variants may be described when the UE 3 performs the registration procedure to the AMF 7001 of PLMN 1, but it is not limited to.

Step 5. The UE 3 performs a cell selection procedure or a cell reselection procedure if the UE 3 receives and stores the list of the S-NSSAI(s) and the associated network slice group identity(ies) from the AMF 7001 or decides on its own to perform the cell selection procedure or the cell reselection procedure. The cell selection procedure may be expressed as cell selection, and the cell reselection procedure may be expressed as cell reselection. The UE 3 may select or reselect a cell to be used. The UE 3 may select or reselect a cell based on the list of the S-NSSAI(s) and the associated network slice group identity(ies). The UE 3 may use the list of the S-NSSAI(s) and the associated network slice group identity(ies) to determine whether a cell supports a particular network slice by checking if the network slice group identity associated with the particular network slice is broadcasted in the SIB in step 3 or not. If the network slice group identity that is associated to the particular network slice is broadcasted in the SIB, the UE 3 determines that the cell supports the particular network slice and stays tuned to the cell. Tuning to the cell may be expressed as selecting or reselecting the cell. The particular network slice may be expressed as a particular S-NSSAI. The particular network slice may be determined based on the Allowed NSSAI or the Requested NSSAI or Configured NSSAI or any other policy (ies). The UE 3 may select or reselect a cell based on the list of the S-NSSAI(s), the associated network slice group identity and the Allowed NSSAI or the Requested NSSAI or Configured NSSAI or any other policy (ies). For example, the UE 3 selects or reselects a cell which broadcasts the network slice group identity corresponding to the S-NSSAI in the Allowed NSSAI or the Requested NSSAI or Configured NSSAI. The UE 3 may select or reselect a cell which broadcasts the network slice group identity associated with highly prioritized S-NSSAI in the Allowed NSSAI. The Allowed NSSAI may include priority information for S-NSSAI(s) included in the Allowed NSSAI.

The UE 3 may select or reselect a cell which broadcasts the network slice group identity associated with highly prioritized S-NSSAI in the Configured NSSAI. The Configured NSSAI may include priority information for S-NSSAI(s) included in the Configured NSSAI.

For example, the UE 3 determines that correspondence between the network slice (or S-NSSAI) and the network slice group identity based on the list of the S-NSSAI(s) and associated network slice group identity received in step 4.

For example, the UE 3 determines that GP ID 1 is associated with (or corresponds to)S-NSSAI 1 based on the first list received in step 4 which includes S-NSSAI 1 and is associated with GP ID 1. For example, the UE 3 determines that GP ID 2 is associated with (or corresponds to)S-NSSAIs 2 and 3 based on the second list received in step 4 which includes S-NSSAIs 2 and 3 and is associated with GP ID 2.

For example, in a case where the UE 3 determines that GP ID 1 is associated with (or corresponds to)S-NSSAI 1 based on the first list received in step 4 which includes S-NSSAI 1 and is associated with GP ID 1, the UE 3 selects or reselects, based on the information received in step 3, a cell which GP ID 1 corresponding to PLMN ID 1 and S-NSSAI 1 is broadcasted.

For example, in a case where the UE 3 determines that the received Allowed NSSAI includes S-NSSAI 1, the UE selects or reselects a cell which GP ID 1 corresponding to S-NSSAI 1 is broadcasted.

For example, in a case where the UE 3 determines that the received Allowed NSSAI includes S-NSSAI 1, the UE 3 selects or reselects, based on the information received in step 3, a cell which GP ID 1 corresponding to PLMN ID 1 and S-NSSAI 1 is broadcasted.

For example, in a case where the Allowed NSSAI includes S-NSSAI 1 and S-NSSAI 2 and priority information for S-NSSAI 1, the UE 3 may select or reselect a cell which broadcasts GP ID 1 corresponding to the S-NSSAI 1.

If the Allowed NSSAI is not received by the UE 3, the UE 3 may select or reselect a cell based on the Requested NSSAI or any other policy.

Steps 6a-6c. When a UE 3 initiates an initial NAS procedure, the UE 3 initiates an RRC connection establishment procedure. The initial NAS procedure may be expressed as a registration procedure.

For example, the UE 3 initiates the initial NAS procedure within the cell after selecting or reselecting the cell in step 5.

For example, the UE 3 initiates the initial NAS procedure within the cell after selecting or reselecting the cell in step 5 in case where the selected cell supports an S-NSSAI in the received Configured NSSAI in step 4 but that S-NSSAI is not in the received Allowed NSSAI in step 4.

The UE 3 may send an RRC Setup Request message to the NG-RAN 5 in step 6a in order to initiate the RRC connection establishment procedure. The UE 3 may receive an RRC Setup message from the NG-RAN 5 in step 6b in response to the RRC Setup Request message.

For example, the UE 3 sends an RRC Setup Complete message in step 6c during the RRC connection establishment procedure. The RRC Setup Complete message is used to confirm the successful completion of the RRC connection establishment procedure.

The RRC Setup Complete message may include the list of network slice group identity(ies) corresponding to the network slice (or the S-NSSAI) in the Allowed NSSAI or the Configured NSSAI or a Requested NSSAI.

For example, in a case where the UE 3 selects or reselects the cell which broadcasts GP ID 1 corresponding to S-NSSAI 1 in step 5, the UE 3 includes GP ID 1 in the RRC Setup Complete message.

For example, in a case where the UE 3 determines that the received Allowed NSSAI includes S-NSSAI 1, the UE 3 includes GP ID 1 corresponding to S-NSSAI 1 in the RRC Setup Complete message.

For example, in a case where the UE 3 includes S-NSSAI 1 in the Requested NSSAI, the UE 3 includes GP ID 1 corresponding to S-NSSAI 1 in the RRC Setup Complete message.

The RRC Setup Complete message may include a registration request message. The registration request message may be called as a registration request, a Registration Request message or a Registration Request in this disclosure.

The registration request message may include the UE capability information which indicates the UE 3 supports a network slice group identity feature.

The registration request message may include a Requested NSSAI which includes S-NSSAI 1 corresponding to GP ID 1. The Requested NSSAI which includes S-NSSAI 1 corresponding to GP ID 1 may be expressed as “Requested NSSAI (S-NSSAI 1=GP ID 1)”.

The registration request message may include the list of network slice group identity(ies) (or GP ID or GP IDs) corresponding to the S-NSSAI(s) in the Allowed NSSAI or the Configured NSSAI or the Requested NSSAI.

For example, the registration request message may include GP ID 1 corresponding to S-NSSAI 1.

The list of network slice group identity(ies) may be also called as allowed network slice group identity(ies).

Step 7. The NG-RAN 5 forwards, to the AMF 7001 by a NGAP INITIAL UE message, the registration request message that is received by the RRC Setup Complete message from the UE 3. On receiving the registration request message, the AMF 7001 processes the registration procedure by using the S-NSSAI 1 corresponding to GP ID 1.

### <Variant 1 of First Example of the First Aspect>

In some examples, the message in the step 1a and step 2a can be a NG SETUP RESPONSE message, a RAN CONFIGURATION UPDATE ACKNOWLEDGE message or an AMF CONFIGURATION UPDATE message as described in NPL 3.

### <Variant 2 of First Example of the First Aspect>

In some examples, the message in the step 1b and step 2b can be a NG SETUP REQUEST message, a RAN CONFIGURATION UPDATE message or an AMF CONFIGURATION UPDATE ACKNOWLEDGE message as described in NPL 3.

### <Variant 3 of First Example of the First Aspect>

In some examples, in step 5, if the UE 3 in RRC-INACTIVE state performs a cell reselection or selection to a cell which doesn't broadcast a slice group identity corresponding to any S-NSSAI(s) present in the Allowed NSSAI, the UE 3 changes the state to RRC IDLE mode (or RRC IDLE state). The UE 3 initiates an RRC connection setup procedure when the UE 3 receives a request to establish a N1 signaling connection. The RRC connection setup procedure may be expressed as an RRC connection establishment procedure.

In some examples, in step 5, if the UE 3 in RRC-INACTIVE state performs a cell reselection or selection to a cell which doesn't broadcast a slice group identity corresponding to any S-NSSAI(s) present in the Allowed NSSAI, the UE 3 initiates resume procedure (e.g., a resume procedure for an RRC connection) upon receiving a trigger to initiate signaling or user data communication and sends the RRC Resume Request message. The resume procedure may be expressed as a resume procedure for an RRC connection. Upon receiving the RRC Resume Request message if the NG-RAN 5 determines that the cell does not support any S-NSSAI present in the Allowed NSSAI of the UE 3, the NG-RAN 5 releases the DRB. The NG-RAN 5 sends RRC setup message to the UE 3 to establish the SRB. The NG-RAN 5 may send RRC setup message to the UE 3 to establish the SRB after releasing the DRB. The NG-RAN 5 initiates a DRB release procedure related to the N2 interface. The NG-RAN 5 may initiate DRB release procedure related to the N2 interface after initiating the DRB release procedure.

### <Variant 4 of First Example of the First Aspect>

After step 5, if the AMF 7001 wants to initiate paging for the UE 3 related to a S-NSSAI and the AMF 7001 wants to initiate signaling related to the S-NSSAI, the AMF 7001 includes the S-NSSAI or a network slice group identity associated with the S-NSSAI in a paging message. The S-NSSAI may mean a S-NSSAI in the Allowed NSSAI or the Configured NSSAI or the Requested NSSAI, or may be determined based on any other policy (ies). When the NG-RAN 5 receives the paging message, the NG-RAN 5 sends, to the UE 3, a paging message including the network slice group identity corresponding to the S-NSSAI together with a UE's identity. The paging message may include the UE's identity. The UE's identity may be expressed as an identity of UE 3. The S-NSSAI may be the one received from the AMF 7001 or the NG-RAN 5 maps the S-NSSAI to network slice group identity. For example, the NG-RAN 5 may map the S-NSSAI to the network slice group identity based on the correspondence between the S-NSSAI and the slice group identity. For example, the correspondence between the S-NSSAI and the slice group identity may be expressed as “GP ID 1= {S-NSSAI 1}” for the UE 3 same as step 1b or step 2b. When the UE 3 receives the paging message, the UE 3 matches the network slice group identity to the S-NSSAI, and initiates the NAS procedure related to the S-NSSAI corresponding to the network slice group identity. The NAS procedure may be expressed as a service request procedure.

### <Second Example of the First Aspect>

This disclosure discloses a method where the NG-RAN assigns a network slice group identity range to each PLMN which shares the NG-RAN. Each PLMN assigns a network slice group identity from the network slice group identity range assigned by the NG-RAN to S-NSSAI supported by the AMF. The AMF configures the S-NSSAI and corresponding network slice group identity as defined in the first example of the first Aspect. A cell connected to the NG-RAN broadcasts the network slice group identity (or the network slice group identities) corresponding to each PLMN to which the NG-RAN is connected.

The detailed processes of the second example of the first Aspect are defined as below:

Step 0. An NG-RAN 5 is shared by PLMN 1 and PLMN 2 and the NG-RAN 5 is connected with AMF 7001 of the PLMN 1 and AMF 7002 of the PLMN 2. The AMF 7001 may be included in Core network (CN) 1. The AMF 7002 may be included in CN 2.

Step 1a. The NG-RAN 5 assigns a network slice group identity range to each PLMN which shares the NG-RAN 5. The NG-RAN 5 may assign a network slice group identity range to PLMN 1. The NG-RAN 5 sends, to the AMF 7001 of the PLMN 1, an existing NGAP message or a new NGAP message indicating a supported range of network slice group identity for the PLMN 1. The NGAP message may be expressed as a NGAP-SLICE GROUP ID ALLOCATION message. For example, the NGAP-SLICE GROUP ID ALLOCATION message may include an information element, GP ID range 1-4. “GP ID range 1-4” may mean that the supported range of network slice group identity is 1 to 4. The network slice group identity may be expressed as GP ID. The supported range of network slice group identity may be called as network slice group identity range in this disclosure.

Step 1b. The AMF 7001 associates a network slice group identity from the network slice group identity range with S-NSSAI(s) and sends, to the NG-RAN 5, an existing NGAP message or a new NGAP message indicating association(s) between the S-NSSAI(s) and network slice group identity. Associating a network slice group identity with S-NSSAI(s) may be expressed as assigning the network slice group identity to S-NSSAI(s). PLMN 1 may assign a network slice group identity from the network slice group identity range assigned by the NG-RAN 5 to S-NSSAI supported by the AMF 7001. The AMF 7001 configures the S-NSSAI(s) and corresponding network slice group identity(ies) as defined in the first example of the first Aspect. The NGAP message may be expressed as NGAP-SLICE GROUP ID CONFIGURATION message. The NGAP-SLICE GROUP ID CONFIGURATION message may include information elements: PLMN ID 1, {GP ID 1, S-NSSAI 1}, and {GP ID 2, (S-NSSAI 2, S-NSSAI 3)}. For example, in a case where the AMF 7001 supports a network slice 1 indicated by S-NSSAI 1, a network slice 2 indicated by S-NSSAI 2 and a network slice 3 indicated by S-NSSAI 3, the AMF 7001 groups the network slices, e.g., a first group including S-NSSAI 1 and a second group including S-NSSAI 2 and S-NSSAI 3. The AMF 7001 associates GP ID 1 with the first group including S-NSSAI 1, and GP ID 2 with the second group including S-NSSAIs 2 and 3, based on the supported range of the network slice group identity which is set to 1 to 4. The AMF 7001 sends, to the NG-RAN 5, the NGAP-SLICE GROUP ID CONFIGURATION message including PLMN ID 1 and information indicating association(s) between the S-NSSAI(s) and the network slice group identity. The PLMN ID 1 may be expressed as a PLMN ID of the AMF 7001. “{GP ID 1, S-NSSAI 1}” and “{GP ID 2, (S-NSSAI 2, S-NSSAI 3)}” may mean that S-NSSAIs 1, 2 and 3 are grouped to the first group including S-NSSAI 1 and the second group including S-NSSAIs 2 and 3, and GP ID 1 is associated with the first group and GP ID 2 is associated with the second group. The AMF 7001 may send, to the NG-RAN 5, the NGAP-SLICE GROUP ID CONFIGURATION message including PLMN ID 1 and information which indicates that the first group including S-NSSAI 1 is associated with GP ID 1 and the second group including S-NSSAIs 2 and 3 is associated with GP ID 2.

Step 2a. The NG-RAN 5 assigns a network slice group identity range to each PLMN which shares the NG-RAN 5. The NG-RAN 5 may assign a network slice group identity range to PLMN 2. The NG-RAN 5 sends, to the AMF 7002 of the PLMN 2, an existing NGAP message or a new NGAP message indicating a supported range of network slice group identity for the PLMN 2. The NGAP message may be expressed as a NGAP-SLICE GROUP ID ALLOCATION message. For example, the NGAP-SLICE GROUP ID ALLOCATION message may include an information element, GP ID range 5-6. “GP ID range 5-6” may mean that the supported range of network slice group identity is 5 to 6. The network slice group identity may be expressed as GP ID.

Step 2b. The AMF 7002 associates a network slice group identity from the network slice group identity range with S-NSSAI(s) and sends, to the NG-RAN 5, an existing NGAP message or a new NGAP message indicating associations between the S-NSSAI(s) and network slice group identity. Associating a network slice group identity with S-NSSAI(s) may be expressed as assigning the network slice group identity to S-NSSAI(s). PLMN 2 may assign a network slice group identity from the network slice group identity range assigned by the NG-RAN 5 to S-NSSAI supported by the AMF 7002. The AMF 7002 configures the S-NSSAI(s) and corresponding network slice group identity(ies) as defined in the first example of the first Aspect. The NGAP message may be expressed as NGAP-SLICE GROUP ID CONFIGURATION message. The NGAP-SLICE GROUP ID CONFIGURATION message may include information elements: PLMN ID 2, and {GP ID 5, S-NSSAI1}. For example, in a case where the AMF 7002 supports a network slice 1 indicated by S-NSSAI 1, the AMF 7002 associates GP ID 5 with S-NSSAI 1 based on the supported range of the network slice group identity which is set to 5 to 6. The AMF 7002 sends, to the NG-RAN 5, the NGAP-SLICE GROUP ID CONFIGURATION message including PLMN ID 2 and information indicating association(s) between the S-NSSAI(s) and the network slice group identity. The PLMN ID 2 may be expressed as a PLMN ID of the AMF 7002. “{GP ID 5, S-NSSAI1}” may mean that GP ID 5 is associated with S-NSSAI 1. The AMF 7002 may send, to the NG-RAN 5, the NGAP-SLICE GROUP ID CONFIGURATION message including PLMN ID 2 and information which indicates that S-NSSAI 1 is associated with GP ID 5.

Step 3. A cell connected to the NG-RAN 5 broadcasts a list of network slice group identity(ies) supported by the cell by an existing SIB or a new SIB. The following format is an example of the SIB. I.e., the cell broadcasts a supported network slice group identity (or supported network slice group identities). Some network slice group identities may be valid and applicable to one associated PLMN. A cell connected to the NG-RAN 5 may broadcast the network slice group identity (or the network slice group identities) corresponding to each PLMN to which the NG-RAN 5 is connected.

SIB X (GP ID 1, GP ID 5)

For example, a gNB or a base station or a (R) AN node or an NG-RAN node broadcasts a SIB or a SIB message including the list of network slice group identity(ies) in the cell. The list of network slice group identity(ies) may include GP ID 1 and GP ID 5. “SIB X (GP ID 1, GP ID 5)” may mean that the SIB or SIB message includes GP ID 1 and GP ID 5.

Step 4. The UE 3 registers to the AMF 7001 of the PLMN 1 and during the registration procedure the AMF 7001 sends a list of the S-NSSAI(s) and associated network slice group identity(ies) to the UE 3 in an existing NAS message or in a new NAS message. The NAS message may be expressed as a registration accept message or a UE configuration update message. The AMF 7001 may also send an Allowed NSSAI and a Configured NSSAI to the UE 3 in the NAS message during the registration procedure. The AMF 7001 may send a list of the S-NSSAI(s) and associated network slice group identity (ie) to the UE 3 for all S-NSSAIs in the Configured NSSAI. For example, the UE 3 and the AMF 7001 perform step 4 in the first example of the first Aspect.

Step 5. The UE 3 performs a cell selection procedure or a cell reselection procedure and a subsequent NAS procedure as defined in the first example of the first Aspect. For example, the UE 3 performs steps 5, 6a-6c in the first example of the first Aspect.

### <Variant 1 of Second Example of the First Aspect>

In some examples, the message in the step 1a and step 2a can be a NG SETUP REQUEST message, RAN CONFIGURATION UPDATE message or an AMF CONFIGURATION UPDATE ACKNOWLEDGE message as described in NPL 3.

### <Variant 2 of Second Example of the First Aspect>

In some examples, the message in the step 1b and step 2b can be a NG SETUP RESPONSE message, a RAN CONFIGURATION UPDATE ACKNOWLEDGE message or an AMF CONFIGURATION UPDATE message as described in NPL 3.

### <Second Aspect>

NPL 6 discloses the Multi-Radio Dual Connectivity. Multi-Radio Dual Connectivity (MR-DC) is a generalization of the Intra-E-UTRA Dual Connectivity (DC) described in NPL 5, where a multiple Rx/Tx capable UE may be configured to utilize resources provided by two different nodes connected via non-ideal backhaul, one providing NR access and the other one providing either E-UTRA or NR access. One node acts as the Master Node (MN) and the other node acts as the Secondary Node (SN). The MN and the SN are connected via a network interface and at least the MN is connected to the core network.

It appears that the system design disclosed by NPL 2 does not properly work in the Multi-Radio Dual Connectivity environment. According to NPL 2, the absolute priority of each of the frequency is provided to UEs by RAN as a part of the slice info. On the other hand, NPL 6 discloses that the SN may use a different frequency band from the one used by the MN. It appears that the system design disclosed by NPL 2 does not properly work in the Multi-Radio Dual Connectivity environment. It is not clear what the slice info and the absolute priority of each of the frequency means in cells that structure the Multi-Radio Dual Connectivity. In the Multi-Radio Dual Connectivity environment, there are multiple frequency available for the UE. It appears that the slice info and the absolute priority of each of the frequency may not help the UEs for a cell selection and a cell reselection in the Multi-Radio Dual Connectivity environment. A frequency being used by the SN needs to be taken into account for the cell selection and the cell reselection.

This disclosure discloses a mechanism that enables a cell selection and a cell reselection based on network slice priority works in the 5GS where the Multi-Radio Dual Connectivity is structured.

In case that the Multi-Radio Dual Connectivity is structured, the MN broadcasts system information taking the SN into account.

In order to make UE aware that frequency band(s) supported by the SN in the Multi-Radio Dual Connectivity configuration, there are several ways to broadcast frequency band(s) supported by the SN by the system information.

### <First Example of the Second Aspect>

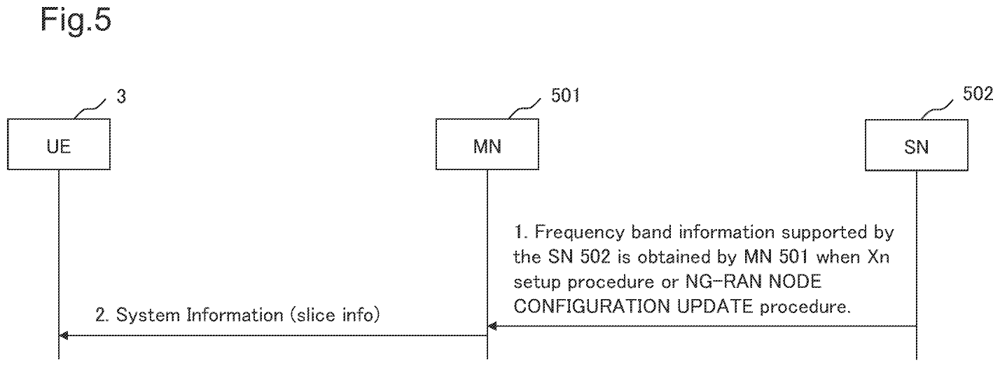

This disclosure discloses a mechanism how the MN obtains frequency band(s) that are supported by the SN. FIG. 5 shows the procedure.

The detailed processes of the first example of the second Aspect are described below.

Step 1. During a Xn setup procedure or an NG-RAN Node configuration procedure, the MN 501 receives Served Cell Information NR or Served Cell Information E-UTRA in the XN SETUP REQUEST message or XN SETUP RESPONSE message or NG-RAN NODE CONFIGURATION UPDATE ACKNOWLEDGE message or any XNAP messages, and stores the Served Cell Information NR or the Served Cell Information E-UTRA as SN related configuration data in the MN 501.

This procedure may be performed in the MN 501 with all connected SNs 502.

Step 2. At least one of the Served Cell Information NR and the Served Cell Information E-UTRA includes frequency band information (or information related to frequency band(s)). The frequency band information may include frequency band(s) supported by the SN 502. All frequency band information received from connected SNs 502 are broadcasted by the MN 501 to UEs 3 over Broadcast Control Channel (BCCH). For example, the MN 501 broadcasts, to UE(s) 3, the system information including the frequency band information received from SN(s) 502 which is connected to the MN 501. The frequency information may be included in the slice info or may be included in the system information independently from the slice info.

There are several ways to broadcast frequency band information of the connected SNs 502. This first example can be applicable to the following examples or following variants that disclose system information structures over the BCCH.

### <Variant 1 of First Example of the Second Aspect.>

In addition to the frequency band information of the connected SNs 502, the MN 501 stores Radio Access Technology (RAT) information associated with the frequency band(s) in step 1. For example, the MN 501 receives the RAT information during the Xn setup procedure or the NG-RAN Node configuration procedure. The MN 501 broadcasts both the frequency band information and the RAT information that are supported by the connected SNs 502 in step 2. The RAT information may indicate RAT type. The RAT type may be expressed as E-UTRA, NR etc.

### <Second Example of the Second Aspect>

This disclosure discloses a structure of the slice info for a cell selection and a cell reselection based on network slice priority when the Multi-Radio Dual Connectivity is structured.

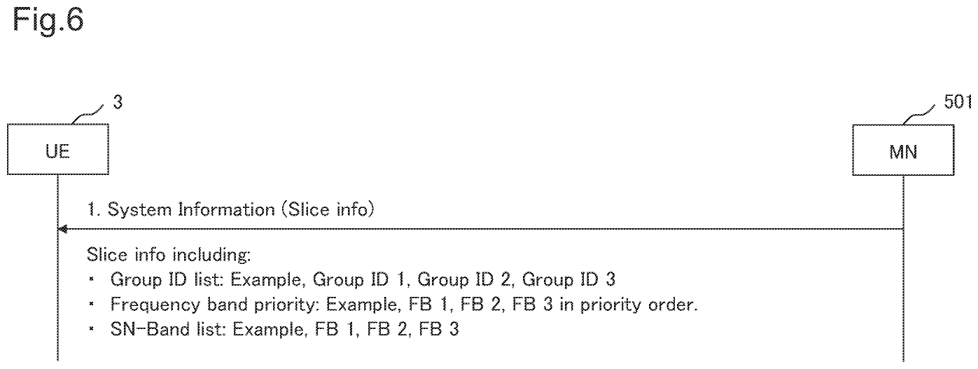

This disclosure discloses a structure of the slice info system information that includes SN band list together with supported network slice group list and Group priority. FIG. 6 illustrates the structure.

The detailed processes of the second example of the second Aspect are described below.

Step 1. The MN 501 broadcasts the following information as a system information for a cell selection and a cell reselection. In addition, the following information can be also provided to the UE 3 dedicatedly by a RRC release message or an existing RRC message. The step 1 of FIG. 6 may be performed in the step 2 of FIG. 5. The information included in the system information may be expressed as cell selection and reselection information. The UE 3 may receive the system information from at least one of a serving cell and neighbouring cell(s). For example, the UE 3 may receive the system information from at least one of a serving MN (e.g., the MN 501 controlling a serving cell) and a neighbouring MN (e.g., the MN 501 controlling a neighbouring cell).

Group ID list: A list of Group ID(s) that the MN 501 supports. As one variation, the Group ID list can include Group ID(s) that the MN 501 and associated SN(s) 502 support. The Group ID may be called as a network slice group identity in this disclosure. The Group ID may indicate an identity indicating a network slice group which includes S-NSSAI(s) or a network slice(s) in this disclosure. For example, priority may be configured for Group ID(s) in the Group ID list. For example, Group ID 1 has the highest priority, Group ID 3 has the lowest priority and Group ID 2 has middle priority between Group ID 1 and Group ID 3.
Frequency band priority: The Frequency band priority indicates a priority order of frequency band(s). The frequency band(s) may be expressed as FB(s). For example, the Frequency band priority may indicate a priority order of Frequency Band(s) of the MN 501. For example, the Frequency band priority indicates that FB 1 has the highest priority, FB 3 has the lowest priority and FB 2 has middle priority between FB 1 and FB 3. The Frequency band priority may be configured for each Group ID in the Group ID list.
SN-Band list: The SN-Band list indicates a list of frequency band(s) which are configured as the SN in the Multi-Radio Dual Connectivity operation. The SN-Band list may indicate a list of frequency band(s) which are configured in the SN in the Multi-Radio Dual Connectivity operation. For example, the MN 501 may obtain the SN-Band list from the SN 502. For example, the MN 501 may obtain the SN-Band list from the SN 502 based on the process in the step 1 of FIG. 5.

The SN-Band list may be configured as the following system information.
Band listMRDC: A list of NR bands which can be configured as SN in the Multi-Radio Dual Connectivity operation with serving for the forwarding of upperLayerIndication to upper layers.
Nr-Bandlist: This field indicates a list of bands and is encoded as a bitmap, where the bit N is set to “1” if the current serving cell supports the Multi-Radio Dual Connectivity operation with the N-th NR band in bandListMRDC. The bits which have no corresponding bands in bandListMRDC is set to 0; bit 1 of the bitmap is the leading bit of the bit string.
Eutra-Bandlist: This field indicates a list of bands and is encoded as a bitmap, where the bit N is set to “1” if the current serving cell supports the Multi-Radio Dual Connectivity operation with the N-th E-UTRA band in bandListMRDC. The bits which have no corresponding bands in bandListMRDC is set to 0; bit 1 of the bitmap is the leading bit of the bit string.

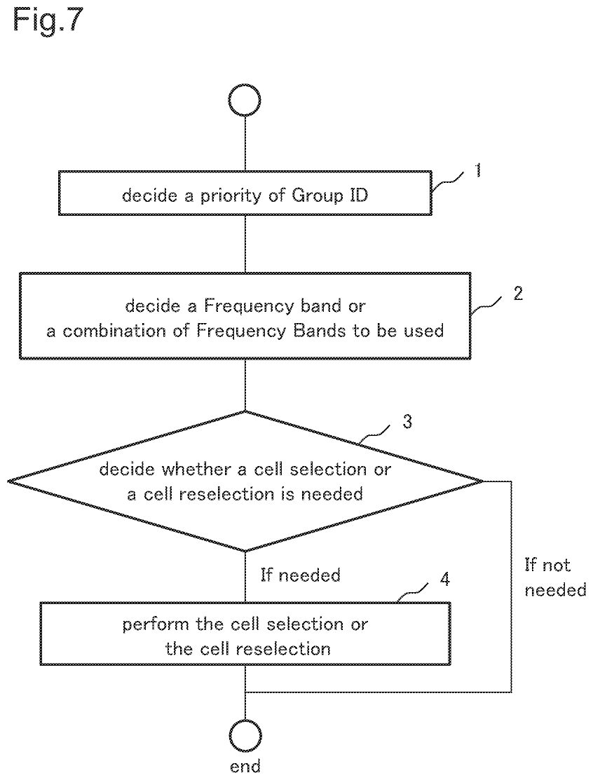

When the UE 3 receives this system information, the UE 3 takes the following steps in FIG. 7 to make a decision whether a cell selection or a cell reselection is needed and which cell the UE 3 moves to. As mentioned below, when the UE 3 makes the decision of the cell selection or the cell reselection, the UE 3 may take strength of signal(s) from cell(s) into account.

Step 1: Based on network slice priority in NAS part of the UE 3, the UE 3 decides the priority of Group ID. The UE 3 may decide the priority of Group ID based on the following steps 1-1 to 1-4.

For example, in step 1-1, the UE 3 has or configures the network slice priority by local configuration of the UE 3. E.g., the UE 3 has or configures the network slice priority indicating that S-NSSAI 1 has higher priority than S-NSSAI 2. In addition to the local configuration of the UE 3, the UE 3 may also decide the network slice priority based on status of PDU sessions associated to the network slices. E.g., a network slice that has an associated active PDU session could be the highest priority while a network slice that has established but does not have an active PDU session could be the second highest priority. In addition to the local configuration of the UE 3, the UE 3 may also decide the network slice priority based on the status of applications in the UE 3. E.g., a network slice that has an associated active application in the UE 3 could be the highest priority.

In step 1-2, the UE 3 receives information indicating which network slice is included in a Group by a NAS message. E.g., the UE 3 receives information indicating that Group 1 which is identified by Group ID 1 (or GP ID 1) includes S-NSSAI 1 and Group 2 which is identified by Group ID 2 (or GP ID 2) includes S-NSSAI 2.

In step 1-3, the UE 3 receives the system information including Group ID as mentioned in step 1 of FIG. 6. E.g., the UE 3 receives the system information including Group ID 1 and Group ID 2 and information indicating that Group ID 1 has higher priority than priority of Group ID 2.

In step 1-4, the UE 3 decides a priority of Group ID based on information in steps 1-1, 1-2 and 1-3. E.g., the UE 3 decides that S-NSSAI 1 is included in the Group 1 which is identified by Group ID 1 based on information in steps 1-1 and 1-2. For example, the UE 3 decides that Group ID 1 corresponding to the S-NSSAI 1 has higher priority than the priority of Group ID 2 based on information in step 1-3.

Step 2: The UE 3 decides a Frequency band or a combination of Frequency bands to be used if the Multi-Radio Dual Connectivity operation is activated. The Frequency band may be expressed as the best Frequency band, and the combination of Frequency bands may be expressed as the best combination of Frequency bands.

For example, the UE 3 decides a frequency band or a combination of frequency bands based on the order of the Frequency band priority that is broadcasted by a RAN Node in one of the System Information messages related to the cell selection and reselection. The RAN Node may include the MN 501 which provides a serving cell, and neighbouring cell(s) if available. The RAN Node may include another RAN Node or other RAN Nodes which provide neighbouring cells. For example, in a case where the Frequency band priority indicates that FB 1 has the highest priority, the UE 3 decides that a cell of FB 1 as the best target cell (or the best Frequency band) for cell selection or reselection.

For example, in a case where the Frequency band priority indicates that FB 1 has the highest priority and FB 3 has lowest priority and FB 2 has middle priority between FB 1 and FB 3, the UE 3 decides FB 1 and FB 2 as the best combination of Frequency bands.

For example, in a case where the UE 3 decides that Group ID 1 corresponding to the S-NSSAI 1 has higher priority than the priority of Group ID 2 in step 1 and the Frequency band priority for Group 1 indicates that FBI has the highest priority, the UE decides FBI as the best Frequency band.

For example, in a case where the UE 3 decides that Group ID 1 corresponding to the S-NSSAI 1 has higher priority than the priority of Group ID 2 and the Frequency band priority for Group ID 1 indicates that FB 1 has the highest priority and the Frequency band priority for Group ID 2 indicates that FB 1 has the highest priority and FB 3 has lowest priority and FB 2 has middle priority between FB 1 and FB 3, the UE 3 decides FBI for Group ID 1 and FB 2 for Group ID 2 as the best combination of Frequency bands. In this case, the UE 3 decides that FB 1 is used for Group ID 1, hence the UE 3 may determine that FB 1 cannot be used for Group ID 2 and decide FB 2 for Group ID 2 which has second priority in the Frequency band priority for Group ID 2.

In another example, the UE 3 may decide the best Frequency band or the best combination of Frequency bands based on local configuration of the UE 3. For example, in a case where the UE 3 decides that Group ID 1 corresponding to the S-NSSAI 1 has higher priority than the priority of Group ID 2 in step 1, the UE 3 decides that FB 1 is suitable for Group ID 1 corresponding to the S-NSSAI 1 and FB 2 is suitable for Group ID 2 corresponding to the S-NSSAI 2 based on local configuration of the UE 3.

Step 3: The UE 3 may make a decision or decide whether a cell selection or a cell reselection is needed and which cell the UE 3 moves to, based on information in steps 1 and 2. The UE 3 may make a decision or decide whether a cell selection or a cell reselection is needed and which cell the UE 3 moves to, by comparing information in steps 1 and 2. Based on the decision in step 2, the UE 3 may choose a cell for selection or reselection based on the received system information from the cell and from the cells (e.g. a serving cell and neighbouring cell(s)) available to the UE 3 and UE radio capability. The received system information may be expressed as cell selection and reselection information. The cells may be expressed as a serving cell and neighbouring cell(s). For example, in a case where the UE 3 decides FB 1 as the best Frequency band, the UE 3 may choose a cell supporting FB 1 or operating in FB 1. The cell may be expressed as a serving cell or a neighbouring cell. For example, in a case where the UE 3 receives the SN-Band list including FB 1, FB 2 and FB 3 and the UE 3 decides FB 1 for Group ID 1 and FB 2 for Group ID 2 as the best combination of Frequency bands, the UE 3 may choose a first cell which is controlled by the MN 501 and supports FB 1 or operates in FB 1 and a second cell which is controlled by the SN corresponding to the MN 501 and supports FB 2 or operates in FB 2. For example, in a case where the cell chosen by the UE 3 is a serving cell, the UE 3 may not perform the cell selection or the cell reselection. The cell chosen by the UE 3 is a serving cell may mean the MN 501 which controls the serving cell sends system information including the Frequency band priority including FB 1 and the SN-Band list including FB 2. The UE 3 not performing the cell selection or the cell reselection may be expressed as the UE staying within the serving cell. In a case where the cell chosen by the UE 3 is a serving cell, the UE 3 may make a decision or decide the cell selection or the cell reselection is not needed and which cell the UE 3 does not move to.

If the UE 3 is on a cell which, based on the cell selection and reselection information broadcasted in the system information, continues to be on the best priority network slice and on the best priority FB and the signal strength of the current cell is still above the required threshold for cell reselection, the UE 3 does not need to perform the cell reselection, i.e., the UE 3 stay on the current cell.

Step 4: Based on the decision in step 3, UE 3 may perform the cell selection or the cell reselection if the cell selection or cell reselection is needed (e.g., the serving cell becomes weak and there are one or more cells better suited as per steps 1 to 3). Alternatively, the UE 3 may trigger the cell selection or the cell reselection immediately if a more suitable cell as per steps 1 to 3 becomes available. For example, the UE 3 performs the cell selection or the cell reselection to the cell(s) chosen in step 3. For example, in a case where the cell chosen by the UE 3 is a neighbouring cell in step 3 (e.g., in a case where a node or a neighbouring MN which controls the neighbouring cell sends system information including the Frequency band priority including FB 1 and the SN-Band list including FB 2), the UE 3 may perform the cell selection for the neighbouring cell or the cell reselection for the neighbouring cell.

In case that the cell selection or the cell reselection may be needed taking the RAT type into account, the following information may be broadcasted. In addition, the following information can be also provided to the UE 3 dedicatedly by an RRC release message or an existing RRC message.
Frequency band priority with RAT type: A Combination of frequency band and RAT type priority indicates a priority order of frequency band/RAT type combination. For example, by using the Frequency band priority with RAT type, the UE 3 may choose at least one of frequency band(s) and cell(s) corresponding to the RAT type.
SN-Band list: A SN-Band list indicates a list of combination of frequency band and RAT type which are configured as SN in the Multi-Radio Dual Connectivity operation. For example, by using the list, the UE 3 may choose at least one of frequency band(s), cell(s), and SN(s) 502 corresponding to the RAT type.

### <Variant 1 of Second Example of the Second Aspect>

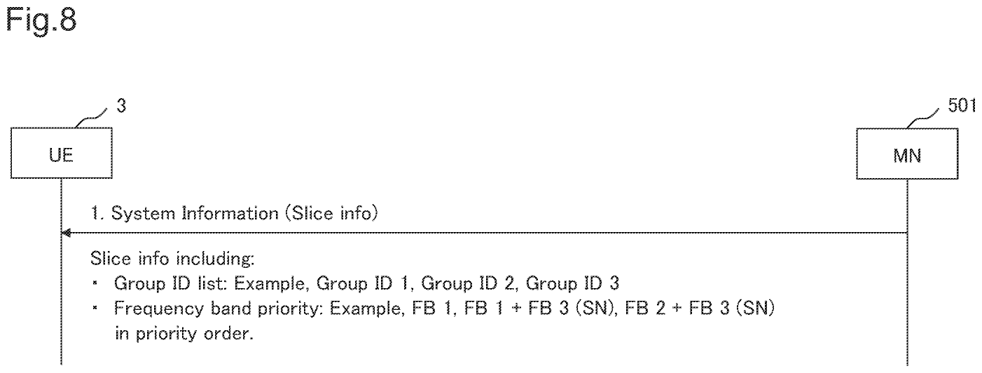

This disclosure discloses a structure of the slice info system information that includes SN band list together with supported group list and Group priority. FIG. 8 illustrates the structure.

The detailed processes of the first variant of the second example are described below.

Step 1. The MN 501 broadcasts the following information as a system information for a cell selection and a cell reselection. In addition, the following information can be also provided to the UE 3 dedicatedly by an RRC release message or an existing RRC message. The step 1 of FIG. 8 may be performed in the step 2 of FIG. 5. The UE 3 may receive the system information from at least one of a serving cell and neighbouring cell(s). For example, the UE 3 may receive the system information from at least one of a serving MN (e.g., the MN 501 controlling a serving cell) and a neighbouring MN (e.g., the MN 501 controlling a neighbouring cell).
Group ID list: A list of Group ID that the MN 501 supports. As one variation, the Group ID list can include Group IDs that the MN 501 and all associated SNs support. For example, priority may be configured for Group ID(s) in the Group ID list. For example, Group ID 1 has the highest priority and Group ID 3 has lowest priority and, Group ID 2 has middle priority between Group ID 1 and Group ID 3.
Frequency band priority: The Frequency band priority indicates a priority order of frequency band(s). Each frequency band information may structure with a frequency band of the MN 501 and a frequency band of the SN for the cell under the Multi-Radio Dual Connectivity operation. “FB 1, FB 1+FB 3 (SN), FB 2+FB 3 (SN) in priority order” may mean that FB 1 has the highest priority, a frequency band combination of FB 2 of the MN 501 and FB 3 of the SN has the lowest priority, and a frequency band combination of FB 1 of the MN 501 and FB 3 of the SN has middle priority between the highest priority and the lowest priority. For example, “FB 1” may mean that FB 1 may be used when Multi-Radio Dual Connectivity operation is not used. “FB 1+FB 3 (SN)” may mean that combination of FB 1 of the MN 501 and FB 3 of the SN may be used when Multi-Radio Dual Connectivity operation is used. “FB 2+FB 3 (SN)” may mean that combination of FB 2 of the MN 501 and FB 3 of the SN may be used when Multi-Radio Dual Connectivity operation is used. The Frequency band priority may be configured for each Group ID in the Group ID list. For example, the MN 501 may obtain the Frequency band of the SN from the SN 502 based on the process in the step 1 of FIG. 5. The MN 501 may structure each Frequency Band information based on the Frequency band of the MN 501 and the Frequency band of the SN. For example, in a case where the MN 501 supports FB 1 and FB 2 and the SN supports FB 3, the MN 501 configures the Frequency Band information including FB 1, a combination of FB 1 and FB 3, and a combination of FB 2 and FB 3.

The UE behaviour when the UE 3 receives this system information is the same as the UE behaviour as described in the second example of the second Aspect. For example, the UE 3 decides a combination of FB 1 of the MN 501 and FB 3 of the SN as the best combination of Frequency bands based on the received Frequency band priority or local configuration of the UE 3. The UE 3 may choose cells operating in FB 1 and FB 3 for the Multi-Radio Dual Connectivity operation. For example, in a case where the UE 3 decides a combination of FB 1 of the MN 501 and FB 3 of the SN as the best combination of Frequency bands, the UE 3 may choose a cell which the system information including Frequency band priority which includes the combination of FB 1 of the MN 501 and FB 3 of the SN is broadcasted (e.g., “FB 1+FB 3 (SN)” is broadcasted). In a case where the cell chosen by the UE 3 is a serving cell, the UE 3 may not perform the cell selection or the cell reselection (i.e., the UE 3 stays within the serving cell). In a case where the cell chosen by the UE 3 is a neighbouring cell, the UE 3 may perform the cell selection for the neighbouring cell or the cell reselection for the neighbouring cell.

In case that the cell selection or cell reselection may be needed taking the RAT type into account, the following information may be broadcasted. In addition, the following information can be also provided to the UE dedicatedly by an RRC release message or an existing RRC message.
Frequency band priority with RAT type: A Combination of Frequency band and RAT type priority indicates a priority order of Frequency Band/RAT type combination. For standalone cells, each entry structures a combination of Frequency Band and RAT type information. For cells under the Multi-Radio Dual Connectivity operation, each entry structures a Frequency Band/RAT type combination of MN and Frequency Band/RAT type combination of the SN. For example, by using the Frequency band priority with RAT type, the UE 3 may choose at least one of Frequency band(s) and cell(s) corresponding to the RAT type. For example, by using the Frequency band priority with RAT type, the UE 3 may choose at least one of Frequency band(s), cell(s), MN and SN(s) corresponding to the RAT type.

### <Variant 2 of Second Example of the Second Aspect>

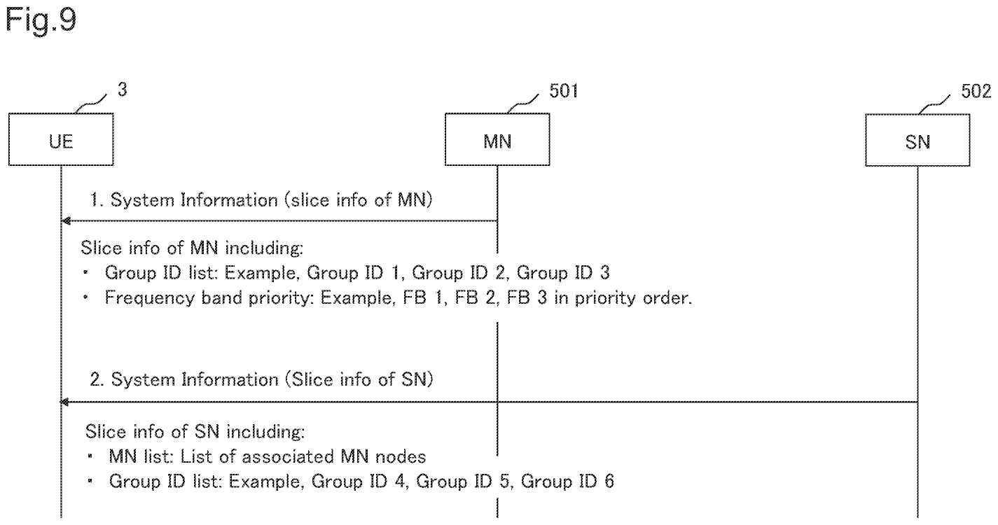

This disclosure discloses a structure of the slice info system information for the Multi-Radio Dual Connectivity operation. FIG. 9 illustrates the system information provided to the UEs.

The detailed processes of the second variant of the second example are described below.

Step 1. The MN 501 broadcasts the following information as a system information for a cell selection and a cell reselection. In addition, the following information can be also provided to the UE dedicatedly by an RRC release message or an existing RRC message. For example, the MN 501 may broadcast an identity of the MN 501. The UE 3 may receive the system information from at least one of a serving cell and neighbouring cell(s). For example, the UE 3 may receive the system information from at least one of a serving MN (e.g., the MN 501 controlling a serving cell) and a neighbouring MN (e.g., the MN 501 controlling a neighbouring cell).
Group ID list: A list of Group ID that the MN 501 supports. As one variation, the Group ID list can consist of Group IDs that the MN 501 and all associated SNs support. For example, priority may be configured for Group ID(s) in the Group ID list. For example, Group ID 1 has the highest priority and Group ID 3 has lowest priority and, Group ID 2 has middle priority between Group ID 1 and Group ID 3.
Frequency band priority: A Frequency band priority indicates a priority order of Frequency Bands. Each Frequency Band information may structure with a Frequency band of MN for the cell under the Multi-Radio Dual Connectivity operation. For example, the Frequency band priority indicates that FB 1 has the highest priority and FB 3 has lowest priority and, FB 2 has middle priority between FB 1 and FB 3.

Step 2. The SN 502 broadcasts the following information as a system information for the cell selection and cell reselection based on network slice priority. In addition, the following information can be also provided to the UE 3 dedicatedly by an RRC release message or an existing RRC message. For example, the UE 3 may receive the system information from at least one of a SN corresponding to a serving MN (e.g., the SN 502 corresponding to the MN 501 controlling a serving cell in the Multi-Radio Dual Connectivity operation) and a SN corresponding to a neighbouring MN (e.g., the SN 502 corresponding to the MN 501 controlling a neighbouring cell in the Multi-Radio Dual Connectivity operation).
MN list: A list of associated MN(s). For example, the MN list includes at least one identity of the associated MN(s).
Group ID list: A list of Group ID that the SN 502 supports. For example, priority may be configured for Group ID(s) in the Group ID list. For example, Group ID 1 has the highest priority and Group ID 3 has lowest priority and, Group ID 2 has middle priority between Group ID 1 and Group ID 3.

The UE behaviour when the UE 3 receives this system information is the same as the UE behaviour as described in the second example of the second Aspect. Note that the UE 3 scans system information broadcasted by the MN 501 and system information broadcasted by the SN(s) 502 in steps 1 and 2. An association of MN 501 and SN 502 can be found by the UE 3 from the MN list information broadcasted by the SN 502. This association helps the UE 3 to know a Frequency band combination between the MN 501 and the SN 502. For example, in a case where the UE 3 receives an identity of the MN 501 from the MN 501 and receives the MN list including the identity of the MN 501 from the SN 502, the UE 3 can recognize or know the association of the MN 501 and the SN 502. For example, in a case where the UE 3 recognizes or knows the association of the MN 501 and the SN 502, the UE 3 may recognize or know that the Multi-Radio Dual Connectivity operation is available by using the MN 501 and the SN 502. For example, in a case where the UE 3 recognizes or knows the association of the MN 501 and the SN 502, the UE 3 may recognize or know that the Frequency band priority received from the MN 501 is also applicable to the SN 502. For example, in a case where the UE 3 decides a priority of Group ID 1 and a priority of Group ID 4, the UE 3 decides the best combination of Frequency bands for the Multi-Radio Dual Connectivity operation (e.g., the UE 3 decides a combination FB 1 for Group ID1 and FB 2 for Group ID4), and may choose cells operating in FB 1 and FB 2 for the Multi-Radio Dual Connectivity operation. For example, in a case where the UE 3 decides a combination of FB 1 and FB 2 as the best combination of Frequency bands, the UE 3 may choose a first cell which is controlled by the MN 501 and which the system information including Frequency band priority which includes FB 1 is broadcasted, and a second cell which is controlled by the SN 502 corresponding to the MN 501. In this case the SN 502 supports FB 2 or operates in FB 2. In a case where the cell (e.g., the first cell) chosen by the UE 3 is a serving cell, the UE 3 may not perform the cell selection or the cell reselection (i.e., the UE 3 stays within the serving cell). In a case where the cell (e.g., the first cell) chosen by the UE 3 is a neighbouring cell, the UE 3 may perform the cell selection for the neighbouring cell or the cell reselection for the neighbouring cell. After selecting the first cell or reselecting the first cell, the UE 3 may perform addition of the second cell as secondary cell(s). After selecting the first cell or reselecting the first cell, the UE 3 may perform addition of the SN controlling the second cell as secondary node(s).

In case that the cell selection or cell reselection may be needed taking the RAT type into account, the following information may be broadcasted. In addition, the following information can be also provided to the UE 3 dedicatedly by the RRC release message or existing RRC messages.
Frequency band priority with RAT type: A Combination of Frequency band and RAT type priority indicates a priority order of Frequency Band/RAT type combination. For standalone cells, each entry structures a combination of Frequency Band and RAT type information. For cells under the Multi-Radio Dual Connectivity operation, each entry structures a Frequency Band/RAT type combination of MN and Frequency Band/RAT type combination of the SN. For example, by using the Frequency band priority with RAT type, the UE 3 may choose at least one of Frequency band(s) and cell(s) corresponding to the RAT type. For example, by using the Frequency band priority with RAT type, the UE 3 may choose at least one of Frequency band(s), cell(s), MN and SN(s) corresponding to the RAT type.

### <System Overview>

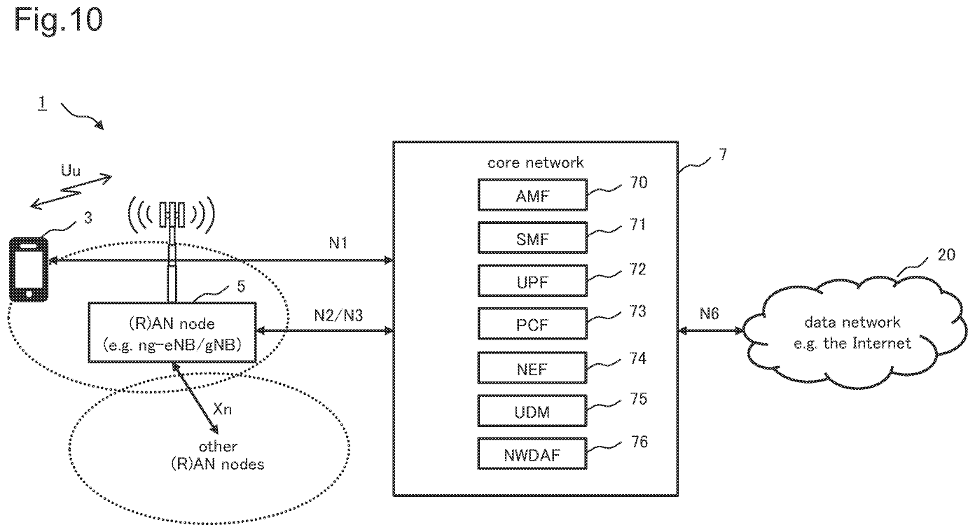

FIG. 10 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R) AN nodes 5 and a core network 7.

The (R) AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R) AN node 5 may split into a Radio Unit (RU), Distributed Unit (DU) and Centralized Unit (CU). In some aspects, each of the units may be connected to each other and structure the (R) AN node 5 by adopting an architecture as defined by the Open RAN (O-RAN) Alliance, where the units above are referred to as O-RU, O-DU and O-CU respectively.

The (R) AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R) AN node 5. This split architecture may be called as ‘dual connectivity’ or ‘Multi connectivity’.

The (R) AN node 5 can also support a communication using the satellite access. In some aspects, the (R) AN node 5 may support a satellite access and a terrestrial access.

In addition, the (R) AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R) AN node 5 as the UE 3 is moving around in the geographical area covered by the telecommunication system 1. In order to keep track of the UE 3 and to facilitate movement between the different (R) AN nodes 5, the core network 7 comprises at least one access and mobility management function (AMF) 70. The AMF 70 is in communication with the (R) AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R) AN node 5 are connected via an appropriate air interface (for example the so-called “Uu” interface and/or the like). Neighboring (R) AN node 5 are connected to each other via an appropriate (R) AN node 5 to (R) AN node interface (such as the so-called “Xn” interface and/or the like). Each (R) AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R) AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R) AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R) AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R) AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R) AN node 5. In addition to the parameters that are disclosed by Aspects in this disclosure, following parameters may be included together in the RRC setup complete message.
guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message. Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.
   <User equipment (UE)>

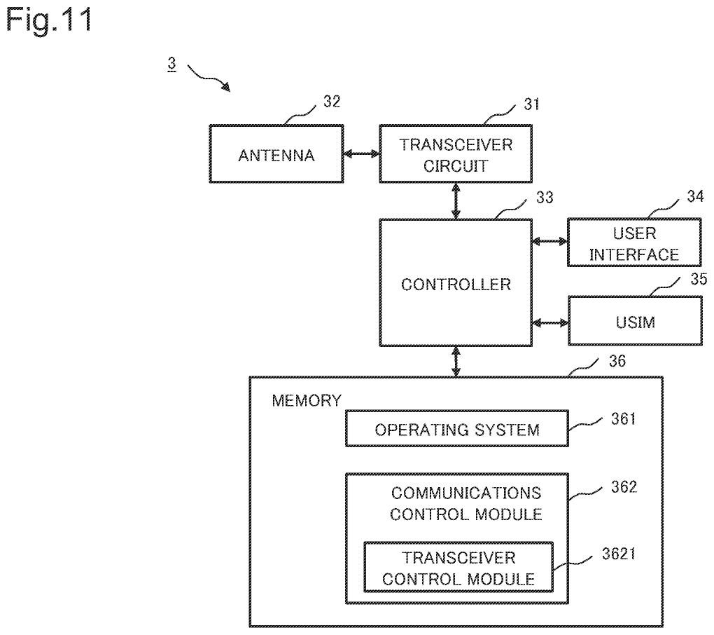

FIG. 11 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R) AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

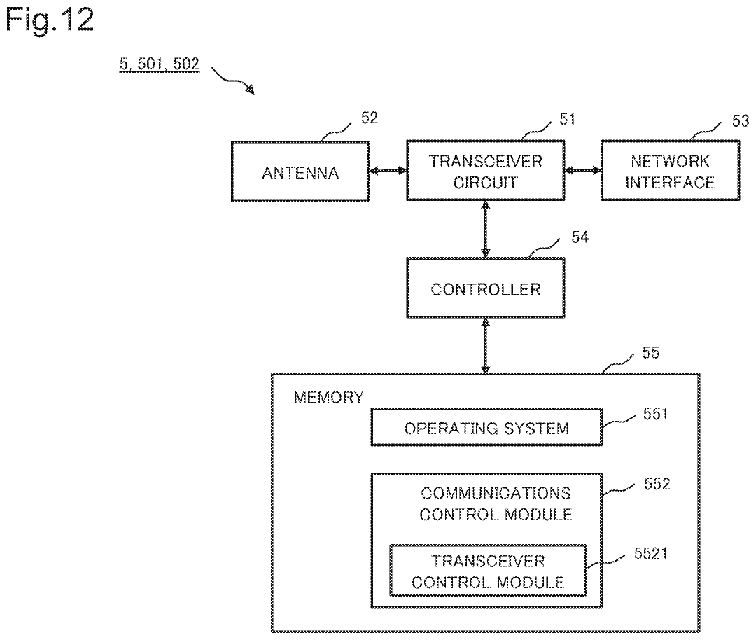

FIG. 12 is a block diagram illustrating the main components of an exemplary (R) AN node 5, for example a base station (′eNB′ in LTE, ‘gNB’ in 5G, a base station for 5G beyond, a base station for 6G). As shown, the (R) AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R) AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R) AN node 5 and other nodes, such as the UE 3, another (R) AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R) AN node 5 may support the Non-Public Network (NPN), The NPN may be a Stand-alone Non-Public Network (SNPN) or a Public Network Integrated NPN (PNI-NPN). A Master Node (MN) 501 and a Secondary Node (SN) 502 may have same components to the (R) AN node 5.

### <System Overview of (R) AN Node 5 Based on O-RAN Architecture>

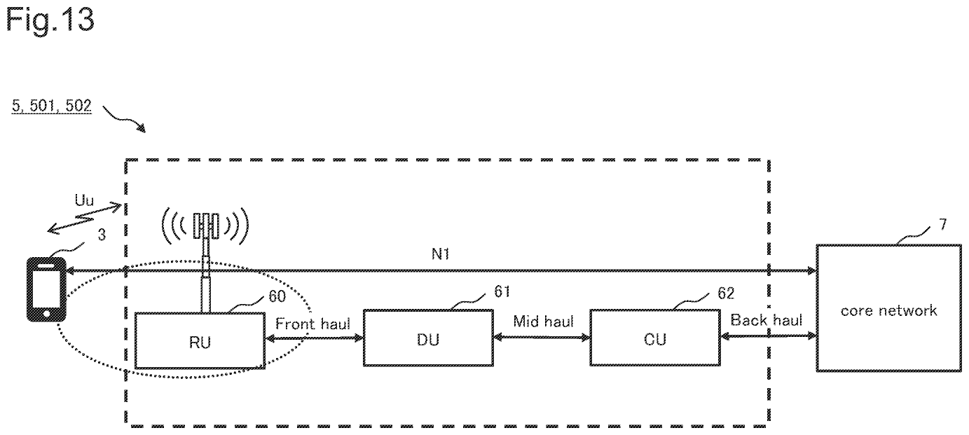

FIG. 13 schematically illustrates a (R) AN node 5 based on O-RAN architecture to which the (R) AN node 5 aspects are applicable.

The (R) AN node 5 based on O-RAN architecture represents a system overview in which the (R) AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R) AN node 5. The CU UP has a user plane functionality in the (R) AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R) AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

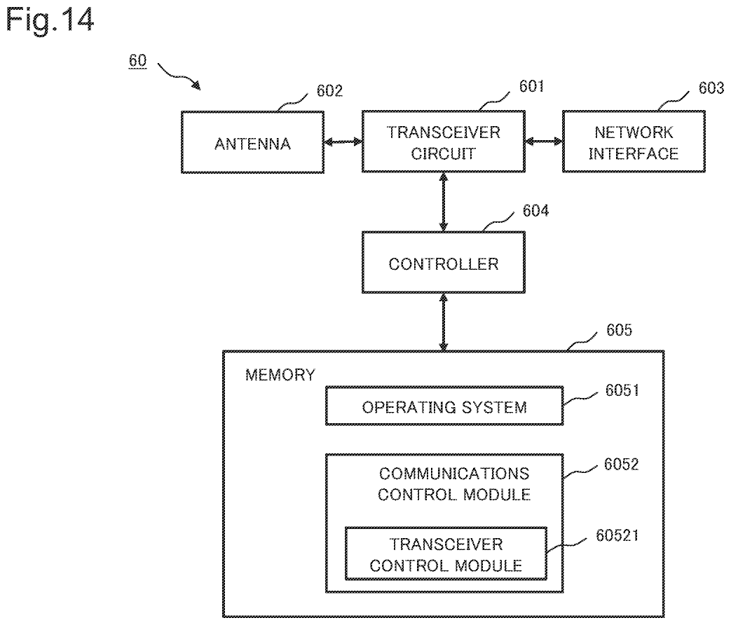

FIG. 14 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

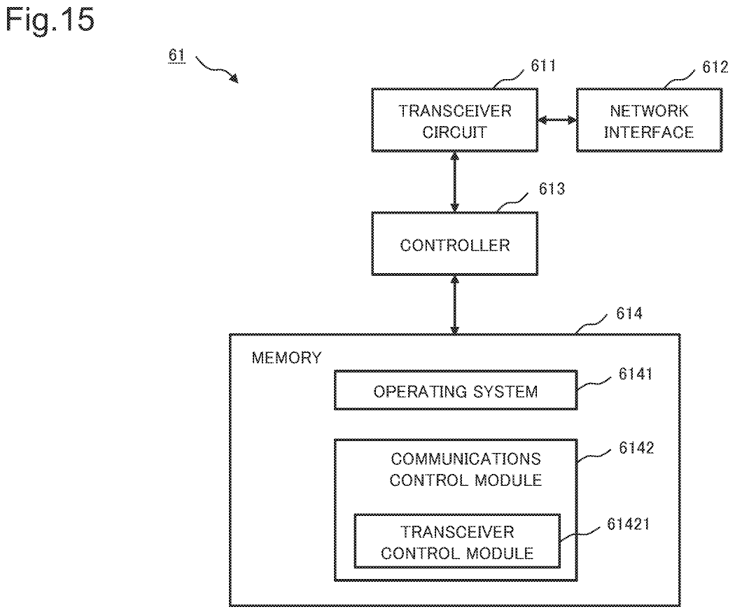

FIG. 15 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

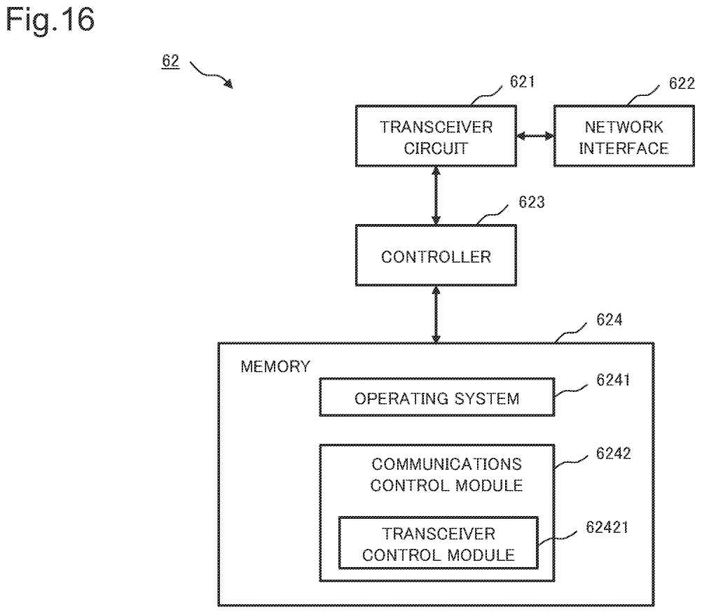

FIG. 16 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

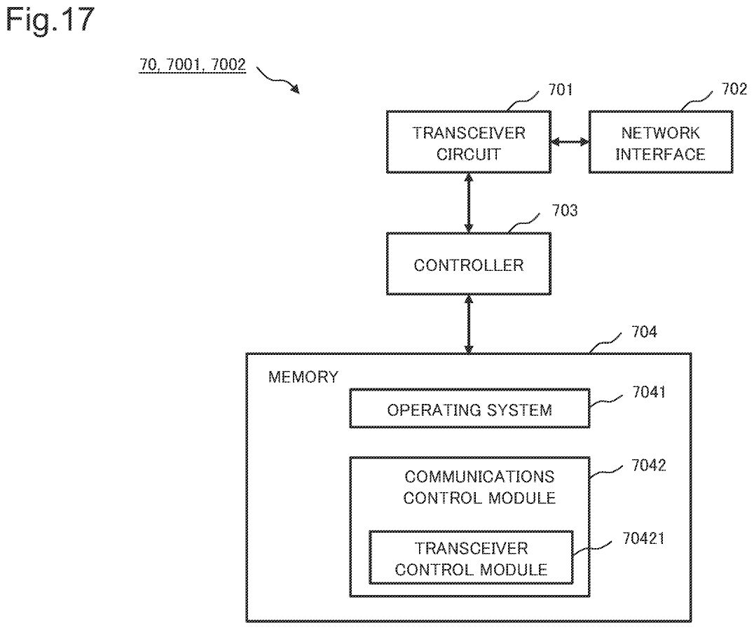

FIG. 17 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R) AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN),

The NPN may be a Stand-alone Non-Public Network (SNPN) or a Public Network Integrated NPN (PNI-NPN). An AMF 7001 and an AMF 7002 may have same components to the AMF 70.

### <UDM>

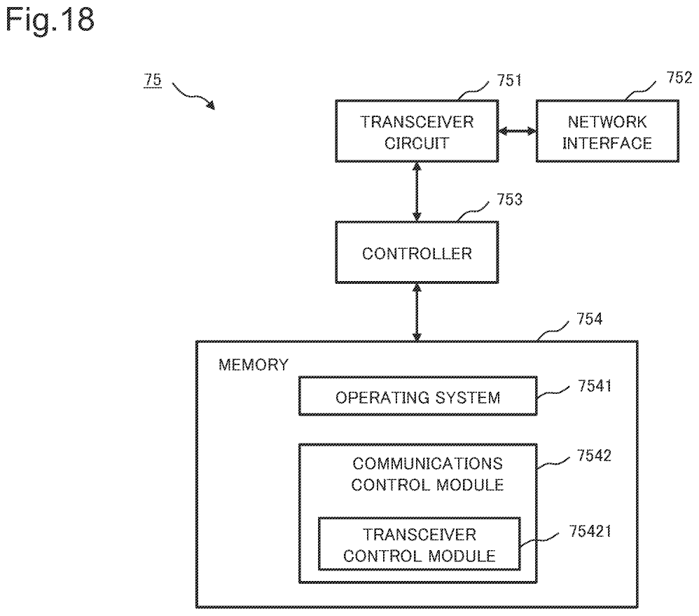

FIG. 18 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### <Supplementary Notes>

The whole or part of the example Aspects disclosed above can be described as, but not limited to, the following supplementary notes.

supplementary note 1. A method of an Access and Mobility Management Function (AMF) apparatus, the method comprising:
sending a first message including a Public Land Mobile Network Identifier (PLMN ID) and Single Network Slice Selection Assistance Information (S-NSSAI);
receiving a second message including the PLMN ID and the S-NSSAI associated with an identifier; and
sending the S-NSSAI associated with the identifier.

supplementary note 2. A method of a Next Generation-Radio Access Network (NG-RAN) node, the method comprising:
receiving a first message including a Public Land Mobile Network Identifier (PLMN ID) and Single Network Slice Selection Assistance Information (S-NSSAI);
sending a second message including the PLMN ID and the S-NSSAI associated with an identifier; and
sending a third message including the identifier associated with the PLMN ID.

supplementary note 3. A method of a User Equipment (UE), the method comprising:
receiving a first message including a Public Land Mobile Network Identifier (PLMN ID) and Single Network Slice Selection Assistance Information (S-NSSAI) associated with an identifier;
receiving a second message including the identifier associated with the PLMN ID; and
performing a cell selection or a cell reselection after receiving the first message and the second message.

supplementary note 4. A method of an Access and Mobility Management Function (AMF) apparatus, the method comprising:
receiving a first message including information indicating range of an identifier;
sending a Public Land Mobile Network Identifier (PLMN ID) and Single Network Slice Selection Assistance Information (S-NSSAI) associated with the identifier; and
sending the S-NSSAI associated with the identifier.

supplementary note 5. A method of a Next Generation-Radio Access Network (NG-RAN) node, the method comprising:
sending a first message including information indicating range of an identifier;
receiving a Public Land Mobile Network Identifier (PLMN ID) and Single Network Slice Selection Assistance Information (S-NSSAI) associated with the identifier; and
sending a third message including the identifier associated with the PLMN ID.

supplementary note 6. A method of a Master Node (MN), the method comprising:
sending a Group Identifier (GP ID) identifying a group which includes Single Network Slice Selection Assistance Information (S-NSSAI), information indicating priority of a frequency band and information indicating a frequency band used by a Secondary Node (SN).

supplementary note 7. A method of a Master Node (MN), the method comprising:
sending Group Identifier (GP ID) identifying a group which includes Single Network Slice Selection Assistance Information (S-NSSAI), and information indicating priority of a frequency band,
wherein the information indicating priority of the frequency band includes priority of frequency band combination which includes a frequency band of the MN and a frequency band of a Secondary Node (SN).

supplementary note 8. A method of a User Equipment (UE), the method comprising:
receiving a Group Identifier (GP ID) identifying a group which includes Single Network Slice Selection Assistance Information (S-NSSAI), information indicating priority of a frequency band and information indicating a frequency band used by a Secondary Node (SN); and
performing a cell selection or a cell reselection based on the GP ID, the information indicating priority of the frequency band and the information indicating a frequency band used by the SN.

supplementary note 9. A method of a User Equipment (UE), the method comprising:
receiving a first Group Identifier (GP ID) identifying a group which includes first Single Network Slice Selection Assistance Information (S-NSSAI), and information indicating priority of a frequency band;
receiving a list of a Master Node (MN), and a second Group Identifier (GP ID) identifying a group which includes second S-NSSAI; and
performing a cell selection or a cell reselection based on the first GP ID, the information indicating priority of the frequency band, the list and the second GP ID.

supplementary note 10. An Access and Mobility Management Function (AMF) apparatus comprising:
means for sending a first message including a Public Land Mobile Network Identifier (PLMN ID) and Single Network Slice Selection Assistance Information (S-NSSAI);
means for receiving a second message including the PLMN ID and the S-NSSAI associated with an identifier; and
means for sending the S-NSSAI associated with the identifier.

supplementary note 11. A Next Generation-Radio Access Network (NG-RAN) node comprising:
means for receiving a first message including a Public Land Mobile Network Identifier (PLMN ID) and Single Network Slice Selection Assistance Information (S-NSSAI);
means for sending a second message including the PLMN ID and the S-NSSAI associated with an identifier; and
means for sending a third message including the identifier associated with the PLMN ID.

supplementary note 12. A User Equipment (UE) comprising:
means for receiving a first message including a Public Land Mobile Network Identifier (PLMN ID) and Single Network Slice Selection Assistance Information (S-NSSAI) associated with an identifier;
means for receiving a second message including the identifier associated with the PLMN ID; and
means for performing a cell selection or a cell reselection after receiving the first message and the second message.

supplementary note 13. An Access and Mobility Management Function (AMF) apparatus comprising:
means for receiving a first message including information indicating range of an identifier;
means for sending a Public Land Mobile Network Identifier (PLMN ID) and Single Network Slice Selection Assistance Information (S-NSSAI) associated with the identifier; and
means for sending the S-NSSAI associated with the identifier.

supplementary note 14. A Next Generation-Radio Access Network (NG-RAN) node comprising:
means for sending a first message including information indicating range of an identifier;
means for receiving a Public Land Mobile Network Identifier (PLMN ID) and Single Network Slice Selection Assistance Information (S-NSSAI) associated with the identifier; and
means for sending a third message including the identifier associated with the PLMN ID.

supplementary note 15. A Master Node (MN) comprising:
means for sending a Group Identifier (GP ID) identifying a group which includes Single Network Slice Selection Assistance Information (S-NSSAI), information indicating priority of a frequency band and information indicating a frequency band used by a Secondary Node (SN).

supplementary note 16. A Master Node (MN) comprising:
means for sending Group Identifier (GP ID) identifying a group which includes Single Network Slice Selection Assistance Information (S-NSSAI), and information indicating priority of a frequency band,
wherein the information indicating priority of the frequency band includes priority of frequency band combination which includes a frequency band of the MN and a frequency band of a Secondary Node (SN).

supplementary note 17. A User Equipment (UE) comprising:
means for receiving a Group Identifier (GP ID) identifying a group which includes Single Network Slice Selection Assistance Information (S-NSSAI), information indicating priority of a frequency band and information indicating a frequency band used by a Secondary Node (SN); and
means for performing a cell selection or a cell reselection based on the GP ID, the information indicating priority of the frequency band and the information indicating a frequency band used by the SN.

supplementary note 18. A User Equipment (UE) comprising:
means for receiving a first Group Identifier (GP ID) identifying a group which includes first Single Network Slice Selection Assistance Information (S-NSSAI), and information indicating priority of a frequency band;
means for receiving a list of a Master Node (MN), and a second Group Identifier (GP ID) identifying a group which includes second S-NSSAI; and
means for performing a cell selection or a cell reselection based on the first GP ID, the information indicating priority of the frequency band, the list and the second GP ID.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 20/2111050760, filed on Nov. 5, 2021, the disclosure of which is incorporated herein in its entirety by reference.

### REFERENCE SIGNS LIST

1 telecommunication system
3 UE
5 (R) AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
361 operating system
362 communications control module
501 Master Node
502 Secondary Node
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
751 transceiver circuit
752 network interface
753 controller
754 memory
3621 transceiver control module
5521 transceiver control module
6051 operating system
6052 communications control module
6141 operating system
6142 communications control module
6241 operating system
6242 communications control module
7041 operating system
7042 communications control module
7541 operating system
7542 communications control module
60521 transceiver control module
61421 transceiver control module
62421 transceiver control module
70421 transceiver control module
75421 transceiver control module

What is claimed is:

1. A method of an Access and Mobility Management Function (AMF) apparatus, the method comprising:
communicating with a Next Generation-Radio Access Network (NG-RAN) node; and
receiving, from the NG-RAN node, a message,
wherein the message includes a Public Land Mobile Network (PLMN) identity and information related to a network slice group for a cell reselection,
wherein the information indicates at least one Single Network Slice Selection Assistance Information (S-NSSAI), and
wherein the information is associated with the PLMN identity.

2. The method according to claim 1,
wherein the message is an NG SETUP REQUEST message or a RAN CONFIGURATION UPDATE message.

3. The method according to claim 1, further comprising:
sending the information to a User Equipment (UE).

4. The method according to claim 3,
wherein the information is sent to the UE by a registration accept message.

5. A method of a Next Generation-Radio Access Network (NG-RAN) node, the method comprising:
communicating with an Access and Mobility Management Function (AMF); and
sending, to the AMF, a message,
wherein the message includes a Public Land Mobile Network (PLMN) identity and information related to a network slice group for a cell reselection,
wherein the information indicates at least one Single Network Slice Selection Assistance Information (S-NSSAI), and
wherein the information is associated with the PLMN identity.

6. The method according to claim 5,
wherein the message is an NG SETUP REQUEST message or a RAN CONFIGURATION UPDATE message.

7. A method of a User Equipment (UE), the method comprising:
communicating with an Access and Mobility Management Function (AMF); and
receiving, from the AMF, a first message,
wherein the first message includes information related to a network slice group for a cell reselection,
wherein the information indicates at least one Single Network Slice Selection Assistance Information (S-NSSAI),
wherein the information is sent from a Next Generation-Radio Access Network (NG-RAN) node to the AMF by a second message, and
wherein the information is associated with a Public Land Mobile Network (PLMN) identity.

8. The method according to claim 7,
wherein the first message is a registration accept message.

9. The method according to claim 7,
wherein the second message is an NG SETUP REQUEST message or a RAN CONFIGURATION UPDATE message.

10. An Access and Mobility Management Function (AMF) comprising:
at least one memory; and
at least one hardware processor coupled to the at least one memory,
wherein the at least one hardware processor is configured to:
communicate with a Next Generation-Radio Access Network (NG-RAN) node; and
receive, from the NG-RAN node, a message,
wherein the message includes a Public Land Mobile Network (PLMN) identity and information related to a network slice group for a cell reselection,
wherein the information indicates at least one Single Network Slice Selection Assistance Information (S-NSSAI), and
wherein the information is associated with the PLMN identity.

11. A Next Generation-Radio Access Network (NG-RAN) node comprising:
at least one memory; and
at least one hardware processor coupled to the at least one memory,
wherein the at least one hardware processor is configured to:
communicate with an Access and Mobility Management Function (AMF); and
send, to the AMF, a message,
wherein the message includes a Public Land Mobile Network (PLMN) identity and information related to a network slice group for a cell reselection,
wherein the information indicates at least one Single Network Slice Selection Assistance Information (S-NSSAI), and
wherein the information is associated with the PLMN identity.

12. A User Equipment (UE) comprising:
at least one memory; and
at least one hardware processor coupled to the at least one memory,
wherein the at least one hardware processor is configured to:
communicate with an Access and Mobility Management Function (AMF); and
receive, from the AMF, a first message,
wherein the first message includes information related to a network slice group for a cell reselection,
wherein the information indicates at least one Single Network Slice Selection Assistance Information (S-NSSAI),
wherein the information is sent from a Next Generation-Radio Access Network (NG-RAN) node to the AMF by a second message, and
wherein the information is associated with a Public Land Mobile Network (PLMN) identity.

13-18. (canceled)
